(19) United States
(12) Patent Application Publication
(10) Pub. No.: US 2003/0120535 A1
(43) Pub. Date: Jun. 26, 2003

(54) Method of processing, analyzing and displaying market information

(76) Inventor: Andrey Duka, Genthod (CH)

Correspondence Address: CHRISTOPHER P. MAIORANA, P.C., 24025 GREATER MACK, SUITE 200, ST. CLAIR SHORES, MI, 48080, US

(21) Appl. No.: 10/313,337

(22) Filed: Dec. 6, 2002

Related U.S. Application Data
(63) Continuation of application No. PCT/IB01/01001, filed on Jun. 8, 2001.

(51) Int. Cl. G06F 17/60

(52) U.S. Cl. 705/10

(57) ABSTRACT

A method for analyzing and forecasting movements of market values and a set of tools that may assist a technical analyst, trader or investor in analyzing and forecasting the movements of market values in a structured and systematic manner. Electronically calculated and generated lines on top of a chart, such as possible support and resistance lines and parameter development trajectories, may be provided for assisting the analyst, trader or investor in forecasting movements and/or delaying decisions for clearer market situations. One or more software program modules may be implemented for determining and/or generating the lines and trajectories.

This is a continuation of International Application PCT/IB01/01001, with an international filing date of Jun. 8, 2001 (Aug. 6, 2001), published in English under PCT Article 21(2).

### FIELD OF THE INVENTION

This invention relates to a method of processing, analyzing and displaying information, generally, and, more particularly to a method of processing, analyzing and displaying market information to assist traders and investors in analyzing and forecasting the movement of stock market values based on recorded historical information.

### BACKGROUND OF THE INVENTION

The analysis of stock market values or other parameters based on historical information is a specialized field of activity called “Market Technical Analysis”, or simply “Technical Analysis”. A goal of performing technical analysis is usually to assist a trader or investor in deciding whether to buy or sell market values, for example currencies, shares or values related to market indexes. Conventional technical analysis is performed by an analyst studying charts of historical parameter changes, for example, presented on a computer screen and applying his experience and knowledge to determine possible trends or trend changes. The parameter is a price or index value for example, selected over certain time frames, such as hourly, daily, weekly, monthly, etc.

The technical analyst uses certain tools to help analyze the information, for example “support” and “resistance” lines can be drawn through low and high peaks, respectively, to determine a band within which the parameter fluctuates.

If the analyst considers that the lines drawn are very representative of the market trend, a drop of the value below the support line may be an indication of the trend reversal suggesting a sell decision. Conversely, a rise above the resistance line would tend to indicate a buy decision. A technical analyst can look at different time frames to distinguish between larger and shorter term trends. Knowledge of “market psychology” and the company or value to which the parameter relates can strongly influence the analyst's perception of the information being analyzed. The analyst thus primarily bases a forecast on intuition and experience. The information analysis tools at the analyst's disposal are typically graphical aids of a very simple nature.

It would be desirable to analyze market values in a more systematic and structured manner, relying less on intuition and guesswork than the conventional methods.

### SUMMARY OF THE INVENTION

The present invention may provide a method and a set of tools therefore to assist a technical analyst, trader or investor in analyzing and forecasting the movement of market values in a more structured and systematic manner than conventional techniques.

The present invention may provide a technical analyst, trader or investor with electronically calculated and generated lines on top of a chart, such as possible support and resistance lines and parameter development trajectories that may assist the analyst in forecasting movements or waiting for clearer market situations.

The present invention may be implemented as one or more software program modules.

### BRIEF DESCRIPTION OF THE DRAWINGS

These and other objects, features and advantages of the present invention will be apparent from the following detailed description and the appended claims and drawings in which:

FIG. 1 is a graph of the daily bar of the exchange rate Euro/US Dollar over the period Apr. 20, 1998 to Jan. 28, 2000;

FIG. 2 is a graph of a trajectory TZ for the section P1a-P1b of FIG. 1 after parameter-normalization in Increment-Change Space in accordance with the present invention, where the vertical axis represents the amplitude of the exchange rate stated as the number of measurement increments r where r=0.005, and the horizontal axis represents the number of successive registered measurement steps;

FIG. 3 is a detailed view of a portion F3 of the trajectory of FIG. 2;

FIG. 4 is a graph showing five different parameters after transformation by parameter-normalization and superposition by aligning their starting points;

FIG. 5 is a graph showing a curve representing an average of the five trajectories of FIG. 4;

FIG. 6A is a detailed graph of a portion of the real curve of FIG. 1;

FIG. 6B is a graph in parameter-normalized Increment-Change Space of a beam of two trajectories based on the curve of FIG. 6A;

FIG. 7A is a graph in Increment-Change Space of the section P1a-P1b of FIG. 1 after transformation to a beam comprising two trajectories representing the same section, but where the starting point of one trajectory relative to the other has been phase-shifted by r/2;

FIG. 7B is a graph showing a beam-average curve in Increment-Change Space representing an average of the two trajectories of FIG. 7A;

FIG. 7C is a graph showing a beam-average curve in Increment-Change Space representing an average of the 200 trajectories derived from the section P1a-P1b of FIG. 1;

FIG. 8A is a graph of the same portion of the real curve of FIG. 1 as shown in FIG. 6A;

FIG. 8B is a graph in time-normalized Increment-Change Space of a beam of two trajectories based on the curve of FIG. 8A;

FIG. 9A is a graph in Increment-Change Space of the section P1a-P1b of FIG. 1 after time-normalized transformation to a beam of two trajectories, where a phase shift comprises τ=r/c=2 days;

FIG. 9B is a graph showing a beam-average curve in time-normalized Increment-Change Space representing an average of the two trajectories of FIG. 9A;

FIG. 10 is a graph of a trajectory in parameter-normalized Increment-Change Space of the section P1a-P1b of FIG. 1, where r=0.02;

FIG. 11 is a graph of a ratio of a calculated parameter localization error ΔR and an experimentally measured value ΔRₑₓₚ of the trajectory sections of FIG. 10;

FIG. 12 is a graph of the line slope 1/n as a function of the measurement increment value r of point P1b of FIG. 1 after transformation in Increment-Change Space with different measurement increment values r;

FIG. 13A is a scheme view showing a section of a trajectory in parameter-normalized Increment-Change Space illustrating a possible direction of the compatible trend;

FIG. 13B is a scheme view showing a section of a trajectory in parameter-normalized Increment-Change Space illustrating a possible direction of the compatible trend;

FIG. 14 is a graph in parameter-normalized Increment-Change Space over the period from October 1999 to January 2000 of the Dow Jones Industrial Average index (DJIA) where the measurement error r=50;

FIG. 15 is a graph in time-normalized Increment-Change Space of section P1a-P1b of FIG. 1, where r/c=2 days;

FIG. 16 is a graph in parameter—normalized Increment-Change Space of the exchange rate Euro/US Dollar of the section P1a-P1b of FIG. 1, where r=0.005;

FIG. 17 is a graph in parameter-normalized Increment-Change Space of the DJIA index since its conception to the year 2000, where r=500;

FIG. 18 is a graph similar to the first part of FIG. 17 (from the starting point until point 71), but with the value r=300;

FIG. 19 is a graph in parameter-normalized Increment-Change Space of the DJIA index since conception with three different trajectories representing trajectories where r=300, r=400, and r=500, respectively, the horizontal axis representing the number of measurement increments and the vertical axis representing the number of measurement values r (such that the DJIA value is different for each trajectory at the same number of measurement steps, for example at number 5 on the vertical axis, the DJIA values for the trajectories are 1500, 2000 and 2500, respectively);

FIG. 20 is a graph of the square of the mean values of the trajectories of FIG. 19;

FIG. 21 is a graph of the relationship between the square of the relative parameter value and t/τ for the trajectory of FIG. 9B in time-normalized Increment-Change Space with τ=2 days;

FIG. 22 is a graph in Increment-Change Space depicting the Euro/USD rate over the period Apr. 20, 1998 to Jan. 28, 2000 (as in FIG. 1) after parameter-normalization with r=0.0206, where starting from point 2 a beam comprising 100 trajectories is obtained, the beam-average curve B22 is shown together with the fastest trajectory F22, and support and resistance lines are superimposed on the graph;

FIG. 23 is a graph similar to the graph of FIG. 22, where starting from point 2 a smoothing procedure is applied to the fastest trajectory F22 from FIG. 22, both the trajectory F23 and beam-average curve B23 are smoothed, the number of smoothing iterations is equal to 4, and four quantum lines with n=1, n=2, n=3 and n=4 are plotted from point 2;

FIG. 24 is a graph of the USD/CHF rate obtained over the period from Apr. 15, 2001 to May 12, 2001, where each point represents an average quote for 10 minutes bar (data supplied by Reuters);

FIG. 25 shows the graph from FIG. 24 after parameter-normalization in Increment-Change Space with increment value r=0.003, with variants of the support (S25a, S25b, S25c) and resistance (R25a, R25b, R25c) lines shown, the development equation curve D25 drawn starting from point 5 with the value of q equal to qₘₐₓ=3.36, where starting from point 6 both the fastest trajectory F25 and the beam-average curve B25 are also shown after the application of ten smoothing iterations and 7 quantum lines are shown for point 6;

FIG. 26 is a schematic view of the overall structure of a data processing system in accordance with the present invention;

FIG. 27 is a flowchart illustrating an example process for determining a recommended minimum value of increment r;

FIG. 28 is a flowchart illustrating an example process for a transformation of real market data into a trajectory in Increment-Change Space;

FIG. 29 is a flowchart illustrating an example process for a smoothing procedure applied to a trajectory in Increment-Change Space;

FIG. 30 is a flowchart illustrating an example process for plotting trend lines;

FIG. 31 is a flowchart illustrating a process for determining a value qₘₐₓ;

FIG. 32 is a flowchart illustrating a process for generating a second trend line on the basis of a first line chosen;

FIG. 33 is a flowchart illustrating an example process for splitting of real market data into a beam of trajectories in the Increment-Change Space;

FIG. 34 is a flowchart illustrating an example process for determination of the fastest trajectory for the beam in the Increment-Change Space;

FIG. 35 is a flowchart illustrating an example process for generating a beam-average curve in the Increment-Change Space;

FIG. 36 is a flowchart illustrating an example process for generation of quantum lines in the Increment-Change Space; and

FIG. 37 is a flowchart illustrating an example process for generating a development equation curve in the Increment-Change Space.

### DETAILED DESCRIPTION OF THE INVENTION

I. Theory Underlying the Invention

The invention is based on a new theory of evolution proposed by the inventor, particularly as applied to the evolution of market parameters. The inventor's premise is that the movement of market prices or other market parameters may be described by the laws of physics, and specifically the laws of motion of material objects. The inventor postulates the following:

The principle of universality:

The laws governing changes in measured material parameters are universal, recurring laws that are true for all types of matter, material objects and measuring instruments.

I. 1) Fundamental Laws of Evolution

From a conceptual point of view, one may consider that an observer receives information on the material world by registering changes in material parameters. The observer generally registers the changes in the material parameters by taking measurements with, for example, instruments. The process of observing material parameter changes is generally objective and is generally carried out by taking measurements. The measurement generally produces a number. The number that reflects a material parameter is generally not exact. The measuring process inevitably entails a measurement error which may be large or small and which depends on the method of measurement and the instrument used. Parameter changes with an amplitude smaller than the measurement error will generally not be registered. When the measurement error appears as a scale unit of the instrument used, the scale unit may be considered to be the increment change that is detected and therefore registered by the instrument used. Thus, any material parameter may be represented as a pair of numbers (e.g., R, r), where R is the value proper and r is a measurement increment. Each time one registers a new parameter value that differs from the preceding one, the registered parameter change is generally equal to the discrete measurement increment such that the value of any material parameter may be represented by an integer number multiplied by a measurement increment r.

The scale of change determined in this way and calibrated in integer numbers does not generally depend on the instrument and generally complies with the principle of universality. The inventor thus proposes the following:

First Law of Evolution:

Registered Change is Always a Measurement Increment

What this in fact means is that the world that we are cognizing is “discrete”. It is not possible to observe the continuous (non-discrete) changes of material parameters. Thus, the process of change can be described as a sequence of changes of integer numbers in time.

On the premise that the theory described herein is universal and therefore true for all material objects without exception, a particular case is considered and extended to all others. If one records a change in spatial coordinate of light with an appropriate instrument, the motion is generally composed of identical steps, each equal to a discrete increment of distance. If one redefines “time” as a number of registered changes (hereinafter “Evolution Time”), the clock will always be constructed of the same form of matter as that to which the parameter under examination belongs. On the basis of the principle of universality, the above definition of time may be extended to all forms of matter and material objects as summarized in the following.

Second Law of Evolution:

The length of time of change is proportional to the number of successively registered changes.

In other words, “Evolution Time” stands still when the amplitude of change in the real parameter is less than the specified measurement increment r. One can construct a two dimensional space for which the universality principle holds true, with one coordinate axis representing the parameter value (for example price) as a number of measurement increments r, and the other coordinate axis representing Evolution Time as the number of successively registered changes. A change in parameter is generally registered when the difference between the last registered parameter and the newly measured parameter equals the chosen value of the measurement increment r. Such a two-dimensional space is hereinafter referred to as “Increment-Change Space”.

It may be noted that the aforesaid Increment-Change Space is dimensionless, since the one axis (e.g., the Y-axis) is a sequence of integers (e.g., representing a number of measurement increments), and the other axis (e.g., the X-axis) is also a sequence of integers (e.g., representing a number of successively registered changes). A parameter in Increment-Change Space is often relative in a double sense: first, the parameter is frequently used as an integer and, second, it is often convenient to set a starting point for the parameter to zero.

In the present application, notions derived from the quantum theory are generally used to describe the movement of a market parameter in Increment-Change Space. In other words, the movement of a market parameter in Increment-Change Space may be considered analogous to the motion of a wave-particle (electron, photon . . . ) and treated as though subject to the physical laws applying to wave-particles. By analogy, the following terms describing the value of a market parameter over time, after transformation in Increment-Change Space, will be used in this application:

| | |
|---|---|
| parameter change trajectory, | generally refers to a curve or line plotting |
| or simply “trajectory”: | the movement of a market parameter in |
| | Increment-Change-Space; |
| mass: | generally refers to a fictive mass given to |
| | a parameter change particle or particles; |
| parameter change particle: | generally refers to a point following a |
| | single trajectory in Increment-Change |
| | Space; |
| parameter change trend, | generally refers to an average linear |
| or simply “trend”: | direction of a trajectory in |
| | Increment-Change Space; |
| parameter change beam, or | generally refers to a plurality of |
| simply “beam”: | trajectories in Increment-Change Space, |
| | each trajectory representing the same |
| | parameter at the same measurement |
| | increment r but with shifted real starting |
| | points; |
| phase shift: | generally refers to shifting the starting |
| | measurement point when transforming a |
| | real parameter curve to a trajectory in |
| | Increment-Change Space; |
| velocity: | generally refers to the rate of change of |
| | the parameter, as represented by the slope |
| | of the trend in Increment-Change Space. |

Considering the above, changes of a market parameter (for example the price of a share on the stock market) over real time may be expressed in Increment-Change Space by applying the following system of equations and inequalities:

Registration of a new parameter value in Increment-Change Space generally takes place when the following condition is met:

|Rᵣₑₐₗ+R_{f}−R_{duka}−R_{duka(0)}|≧r (i)

where: Rᵣₑₐₗ is the current value of the parameter in real space; R_{f} is a value which meets the condition |R_{f}|<r, chosen in such a way as to facilitate splitting into a beam or effecting a “phase shift”; R_{duka} is the current (latest) registered value of the parameter in Increment-Change Space; the term appearing in the left-hand part of the inequality diminishes abruptly each time a new parameter value is registered; and R_{duka(0)} is the parameter value by which the parameter scale in Increment-Change Space is shifted in relation to the parameter scale in real space. This makes it possible to combine the starting point of the trajectory with the start (zero point) of the coordinates R_{duka}=0 in Increment-Change Space. The starting point R_{duka}=0 is generally used for convenience. At the same time nothing is changed in principle if the starting point is fixed by some other value.

The values of the parameter R_{duka} allowed in Increment-Change Space may be determined in accordance with the following equation:

R_{duka}=±ir (ii)

where: i=0, 1, 2, 3 . . . is a series of integers, and r>0 is the increment or the absolute value of the difference between any two adjacent parameter values successively registered in Increment-Change Space.

The time interval t_{duka} in Increment-Change Space is also a discrete sequence of values that may be expressed by the equation:

t_{duka}=τN (iii)

where: N=0, 1, 2, 3 . . . is the number of registered changes of the parameter in Increment-Change Space during the time interval t_{duka}, and τ>0 is the constant time interval between any two adjacent parameter values successively registered in Increment-Change Space.

The transformation described above is generally referred herein as “parameter-normalization” since the changes in the market parameter are registered at each change of the parameter by the increment r. It is however also possible to effect a transformation from real space to Increment-Change Space by considering real time as the parameter and the real parameter as successive increases or decreases in registered changes. Such a transformation is generally referred to herein as “time-normalization” and is generally governed by the system of equations and inequalities set out below.

The registration of a new parameter value in time-normalized Increment-Change Space may be determined by the following equation:

tᵣₑₐₗ=tᵣₑₐₗ₍₀₎+τN+t_{f} (iv)

where tᵣₑₐₗ is the current time value in real space at the moment of registration of the parameter in time-normalized Increment-Change Space (any interruptions in the de facto existence of the parameter in real space, e.g. non-working days, are left out of account if they impede the regular reflection of the real-time data in Increment-Change Space); tᵣₑₐₗ₍₀₎ is the initial moment of time in real space (corresponds to N=0); N=0, 1, 2, 3 . . . is the serial number of the parameter changes registered in time-normalized Increment-Change Space; τ>0 is the time interval between any two adjacent parameter values successively registered in time-normalized Increment-Change Space; and t_{f} is a value which meets the condition |t_{f}|<τ, chosen in such a way as to permit splitting into a beam or effecting a “phase shift”.

Every change in the value of the parameter in time-normalized Increment-Change Space may be determined in accordance with the following formula:

$$Δ {R}_{duka} = \frac{r Δ {R}_{real}}{\vert Δ {R}_{real} \vert} \qquad ( v )$$

where ΔR_{duka} is the change in the parameter when a new value is registered in Increment-Change Space relative to the preceding value in time-normalized Increment-Change Space (e.g., if ΔRᵣₑₐₗ=0, then ΔR_{duka} equals its preceding value, or else it is determined by some other reasonable method chosen at will); r>0 is the absolute value of the difference between any two adjacent parameter values successively registered in time-normalized Increment-Change Space; and ΔRᵣₑₐₗ is the parameter change in real space during the time that has elapsed since the preceding registration.

Finally, the scale of permitted time values in time-normalized Increment-Change Space may be expressed by the following equation:

t_{duka}=t_{duka(0)}+τN (vi)

where: t_{duka} is the scale of the permitted time values in time-normalized Increment-Change Space, and t_{duka(0)} is the time value set at N=0, which makes it possible (if desired) to combine the starting point of the trajectory with the zero point of the time count (or any other point fixed as the starting point) in time-normalized Increment-Change Space.

The pattern of change of any market parameter in Increment-Change Space may be presented, in one example, as a broken (or dashed) line in which the segments have the same angle of inclination with respect to the time axis. A physical analog with which we are familiar is the trajectory of the motion of a light ray along one axis, subject to the condition that “U-turns” are possible only at “specially marked” points on the respective axis, (e.g., points located at identical intervals equal to the value of the increment of measurement). The analogy to light is somewhat idealized but extremely useful for our further investigations. Following the principle of universality, the physical laws of motion of a light ray may be extended to the change of market parameters. Since the physical analog has been determined to exist in a stable manner in the conditions described above only as a wave with a length equal to double the measurement increment r, in Increment-Change Space the motion of any parameter may be interpreted as a wave process with the same wavelength. Such an interpretation generally establishes the basis for applying techniques and methods of wave mechanics when analyzing the process of change of parameters in Increment-Change Space, and generally represents the third law of evolution.

Third Law of Evolution:

The process of change may be described as a material wave-particle motion in which the wavelength is equal to double the measurement increment r and the rest mass is equal to zero.

Thus the motion of a market parameter in Increment-Change Space is physically similar to the motion of light, but it is not light.

It is important to understand that the properties of a trajectory describing changes of a market parameter in Increment-Change Space are generally related to the value of the measurement increment r, which can take any value in the range from zero to infinity. In other words, waves describing the process of change of parameters in Increment-Change Space (hereinafter “parameter change wave”, or simply “wave”) theoretically have an unlimited spectrum of wavelengths. For example, for any given wavelength a shorter wavelength may be found in which the representation of the process of change is generally more precise and detailed. Thus, the length of a wave is generally not an absolute characteristic—the length is always relative, as is the pattern of the process of change at that wavelength. The essential point here, however, is that development of the process of change at any possible wavelength in the infinitely wide range must be governed by universal laws and must be independent. This independence means that development processes at different wavelengths do not influence each other. Nevertheless the pattern of changes at shorter wavelengths generally supplements and determines the corresponding pattern of long waves.

I. 2) Application of Physical Laws

Considering the above, in the following section the laws of Physics are generally applied by analogy to the process of change of a market parameter plotted in Increment-Change Space.

The wavelength λ and frequency ν of a parameter change wave may be expressed as follows:

λ=2r (1)

$$v = \frac{1}{2 τ} \qquad ( 2 )$$

where τ=r/c and c is the maximum possible velocity of change in Increment-Change Space. τ thus represents the time in Increment-Change Space that it takes to register each change of the parameter by the increment value r.

In the following development, we shall apply, by analogy, the laws of Quantum Mechanics Theory, which describe the behavior of wave-particles, to the process of change of market parameters in Increment-Change Space.

The momentum P of a parameter change wave at a selected wavelength equals

$$P = \frac{h}{λ} = \frac{h}{2 r} \qquad ( 3 )$$

where h is an analog of the Planck constant. Considering further that

P=MV (4)

where M and V are the mass and the velocity of the parameter change particle, respectively, the law of conservation of momentum may be expressed as follows:

$$P = \frac{h}{2 r} = MV = const . \qquad ( 5 )$$

Applying Einstein's law, the following is true for the effective mass of the parameter change particle:

$$M = \frac{E}{{c}^{2}} \qquad ( 6 )$$

where E represents the energy of the parameter change particle. Moreover, according to Planck, energy can take only the quantum values

E=nhv (7)

where n=1, 2, 3 . . . , and where the parameter change wave frequency is connected with the wave length of the parameter change wave by the known ratio

λν=c (8)

Taking expressions (5), (6) and (7) into consideration we arrive at

$$\frac{h}{2 r} = \frac{{nhvV}_{n}}{{c}^{2}} = const \qquad ( 9 )$$

where Vₙ is the velocity of the parameter change particle corresponding to the quantum number n.

The rule of the quantization of the velocity of the parameter change particle follows there from and may be expressed by the following equation:

$${V}_{n} = \frac{c}{n} , where n = 1 , 2 , 3 … \qquad ( 10 )$$

We should therefore meet the effect of quantization of the velocity of the parameter change particle, and therefore of the trajectory describing the evolution of a market parameter in Increment-Change Space. This is verified further on when concrete examples are discussed.

One of the consequences of accepting the quantum hypothesis is the applicability of the Heisenberg uncertainty principle:

ΔRΔP≈h (11)

where ΔR stands for the uncertainty of the coordinate of the parameter change particle and therefore of the trajectory describing the motion of the particle (localization of the parameter) and ΔP stands for the uncertainty of the parameter change particle momentum.

Let us consider an experiment designed to determine ΔP. Given that in practice we can measure only the trajectory velocity, let us concentrate on the determination of V and ΔV. It is understood that ΔP is functionally related to V and ΔV. As a consequence of P=MV, ΔV may be expressed as follows:

ΔP=\sqrt{M²ΔV²ΔM²V²} (12)

The mass M of the parameter change particle is generally expressed through V as a consequence of equation (5)

$$M = \frac{h}{2 rV} \qquad ( 13 )$$

From which it follows that:

$$Δ M = \vert \frac{ⅆ M}{ⅆ V} \vert Δ V = \frac{h Δ V}{2 {rV}^{2}} . \qquad ( 14 )$$

Let us insert equations (13) and (14) in equation (12)

$$Δ P = \frac{h Δ V}{rV \sqrt{2}} \qquad ( 15 )$$

Applying the law of quantization of velocities, we can write:

$$Δ V = \vert \frac{ⅆ V}{ⅆ n} \vert Δ n = \frac{c Δ n}{{n}^{2}} \qquad ( 16 )$$

By combining expressions (16), (15) and (10) we derive the following equation:

$$Δ P = \frac{h Δ n}{rn \sqrt{2}} \qquad ( 17 )$$

Inserting the result in equation (11), we obtain the uncertainty relation for the parameter change particle in the following form:

$$Δ R \approx \frac{\sqrt{2} rn}{ Δ n} \qquad ( 18 )$$

It remains to determine Δn. As we know that n is a discretely changing quantum number, it is determined in advance that Δn will generally be close to unity. We cannot, however, state with absolute certainty that Δn=1. Accordingly, on the understanding that Δn is a number of the order of unity, the numerical coefficient q=\sqrt{2}/Δn may be introduced. With this coefficient, the uncertainty relation may be stated in a more convenient form:

$$Δ R \approx qrn = \frac{q λ n}{2} \qquad ( 19 )$$

This formulation also automatically eliminates the question of the coefficient which, generally speaking, may be put in front of h in expression (11). By tacit assumption we took it to be equal to unity. Even if it is not equal to unity, however, the coefficient q successfully “absorbs” this awkwardness and seems to dispose of it completely. Furthermore, by using the parameter q we avoid yet another awkwardness. The formula for the momentum localization (expression 12) is generally not exclusive. For example, the formula may either be written in linear form ΔP=MΔV+ΔMV or expressed in other ways. But the difference between these approaches entails the emergence of a numerical factor of the order of 1. Clearly this factor may also be absorbed by q.

The precise definition of q in each particular case is one of the major practical problems of the theory of evolution. Later we shall explore this question in more detail, but for the time being we shall use the value q=\sqrt{2}. It should also be noted that here and further on n must be taken to mean, not a discrete series of integer values, but a continuously changing average value. In fact, by assuming a non-zero Δn, we are obliged to acknowledge the existence of the scatter of n, (e.g., a certain quantum number distribution). Even though n is an integer value distribution, the mean value of n is generally changing continuously.

The expression (19) thus establishes a direct connection between the wavelength at which the trajectory is observed, the quantum number of the trajectory and the vertical distance ΔR between the borders of the band within which the trajectory moves. Since we are conducting the trajectory analysis in Increment-Change Space we must pay attention to the error in the determination of ΔR. The measurement unit here is r, (e.g., half the length of the parameter change wave). Given that the length of a section of a parameter change trajectory between two points is determined as ΔR=R₁−R₂, the error of the result is generally related to the errors of the measurements of the coordinates δR₁=δR₂=r in the following way:

δΔR=\sqrt{(δR₁)²+(δR₂)²}=r\sqrt{2} (20)

This enables us to estimate the relative error of the measurements:

$$\frac{δ Δ R}{Δ R} \approx \frac{1}{n} \qquad ( 21 )$$

Hence it may be concluded that in the range of low n, where the error is of the order of 100%, it is unrealistic to expect quantitative correspondence from the measurements. Conversely, we may expect the analysis of concrete examples to yield sound, stable results in the high n range, where the error diminishes as 1/n, as will be shown with the verification of the various results of this theory in the examples section below.

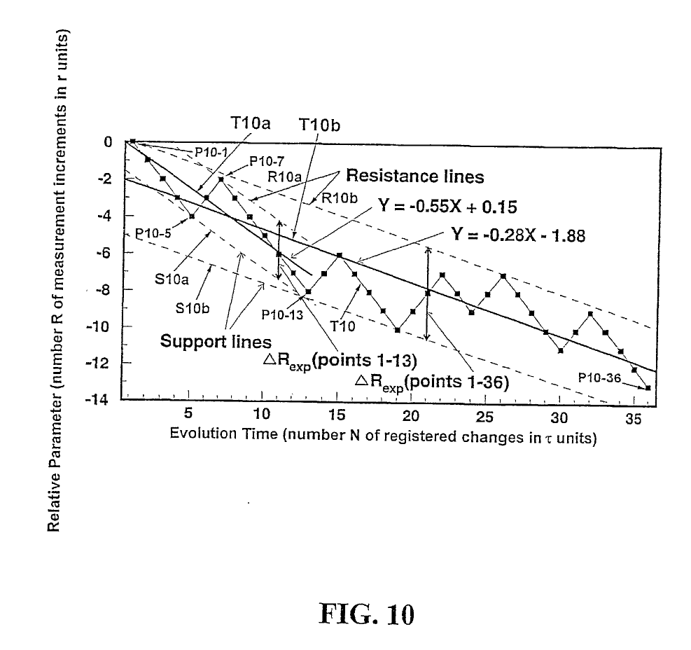

The uncertainty relation has an important property which may make it easier to conduct an experimental verification. The geometrical representation of the parameter localization error ΔR is generally represented by the distance between the high and low peak values of the parameter change trajectory measured as the distance in the direction of the parameter axis (e.g., Y-axis), between upper (resistance) and lower (support) lines (e.g., lines R10a, R10b, S10A, S10B) traced through extreme points as illustrated in FIG. 10. When n>>1 and the measurement error of ΔR is small, the following is true:

ΔR_{n,y}≈ΔR_{n′,y′}≈constant (22)

Where ΔR_{n,r} and ΔR_{n′,r′} are the magnitudes of the parameter localization for different values r and r′ of the measurement increment respectively. In other words, the value of ΔR is substantially independent of the choice of the measurement increment r for a large number of measured changes.

Compliance with this requirement is more easily verified by the rule of transformation of the quantum number n of the trajectory points when passing from one Increment-Change Space in which the value of the measurement increment is r, to another in which the value of the measurement increment is r′ different from r, where

rn≈r′n′r≈inv≈constant (23)

This rule may be confirmed by experimental verification as shown below.

In concluding this section it is useful to add the following. A correlation interconnecting the magnitudes of the measurement increment r and the quantum number n on the scale of the real space parameter/time chart may be derived from expression (23) by means of a simple transformation using the substitution n=(t/τ)/(R/r) and n′=(t/τ′)/(R/r′). Here τ and τ′ stand for the average intervals in real time taken up by single changes of the parameter r or r′ as the case may be. After the substitution, t and R, which do not depend on the choice of the measurement increment because they are coordinates in real space, may be cancelled out and the following invariant relationship obtained:

r²/τ≈(r′)²/τ′≈inv≈const.

II. Experimental Verification of the Theory

II. 1) Quantum Effect

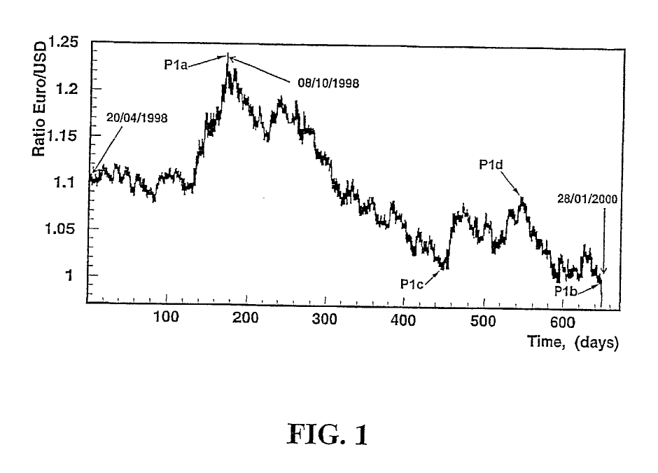

The properties of a parameter change trajectory may now be defined and described. Consider a chart as shown in FIG. 1 representing the changes of a market parameter in real time. In this particular example, the market parameter is the quoted exchange rate of the Euro to the US dollar (i.e. the ratio of Euros per USD) from Apr. 20^{th} 1998 to Jan. 28th 2000, on a daily bar basis, the data being provided by Aspen Research Group.

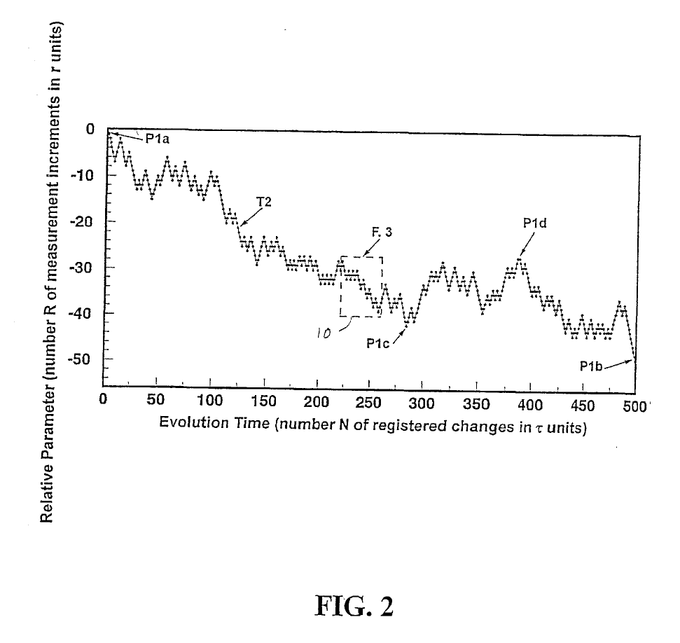

FIG. 2 shows the section P1a-P1b (from Oct. 8, 1998 to Jan. 28, 2000) of the chart of FIG. 1 in Increment-Change Space. The real parameter information has been transformed by applying the expressions (i) to (iii) for parameter normalization. In so doing, the absolute real parameter scale along the vertical axis in FIG. 1 has been transformed into the relative parameter scale (expressed as a number of measurement increments r) along the vertical axis in FIG. 2. Moreover, the real time (in days) along the horizontal axis in FIG. 1 has been transformed into Evolution Time along the horizontal axis in FIG. 2 (as described in the above section “First Law of Evolution”) and expressed as a number of registered changes N as defined in expression (iii). In this example of transformation into Increment-Change Space, r was given the value 0.005. According to expression (iii), the number of registered changes N is expressed as a number of τ units. It is to be noted that the values along the vertical axis representing the real space market parameter (e.g. price, exchange rate, etc . . . ) shown in FIG. 1 generally correspond essentially to the values along the vertical axis representing the relative parameter in Increment-Change Space, as shown in FIG. 2, except that the latter is expressed in a number of measurement steps (e.g., r units) and the origin is set at zero. The horizontal axes of the charts of FIGS. 1 and 2 however do not correspond.

Looking at the pattern of motion as depicted by the trajectory T2 in FIG. 2, the existence of a quantum effect is not generally apparent due to the fact that, for the visual observation of quantum properties, simple graphical plotting of the trajectory of one parameter change particle is generally not sufficient. It may be shown that the rule of quantization of the velocity (Equation 10) of the parameter change trajectory (Vₙ=c/n, where the quantum number n=1, 2, 3 . . . ) is met by examining the changes of a set of parameters (hereinafter called a “beam”) in Increment-Change Space. In other words, the manifestation of the quantization or quantum effect has a statistical character. Independently of discussing exclusively the statistics of a coherent beam, such quantization must be typical even for the statistical drift in space of one parameter change particle if the drift is taking place at a stable average velocity.

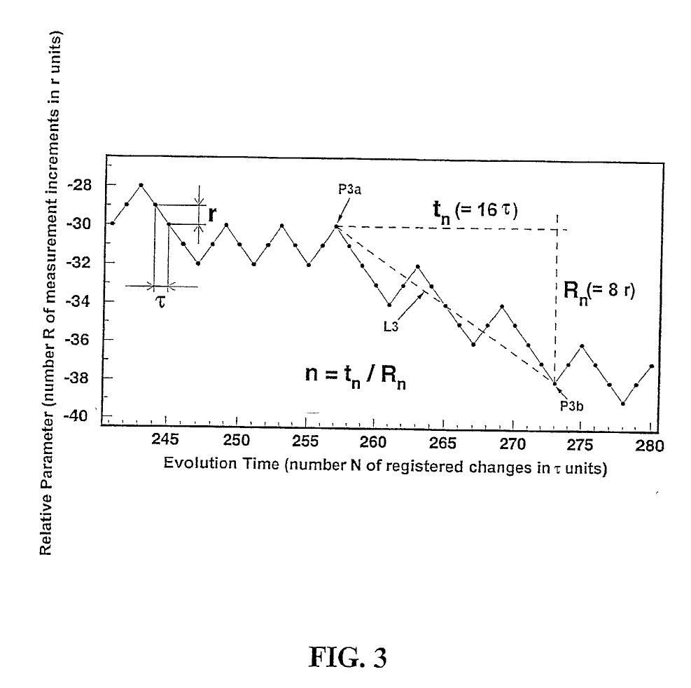

FIG. 3 shows, at an enlarged scale, the section as delineated by the dashed box F.3 in FIG. 2. As can be seen in FIG. 3, the average velocity Vₙ of the trajectory between points P3a and P3b may be defined by the slope of the line L3, which is equal to Rₙ/tₙ. The maximum velocity c is equal to r/τ. The wavelength λ may be determined at will by choosing the value of r. If τ is given the same magnitude as r, such that c=1, then the quantum value n of the line L3 is equal to 1/Vₙ according to expression (10). In other words: n=tₙ/Rₙ. In this particular example, tₙ=16τ and Rₙ=8 r, such that n=2 and Vₙ=0.5.

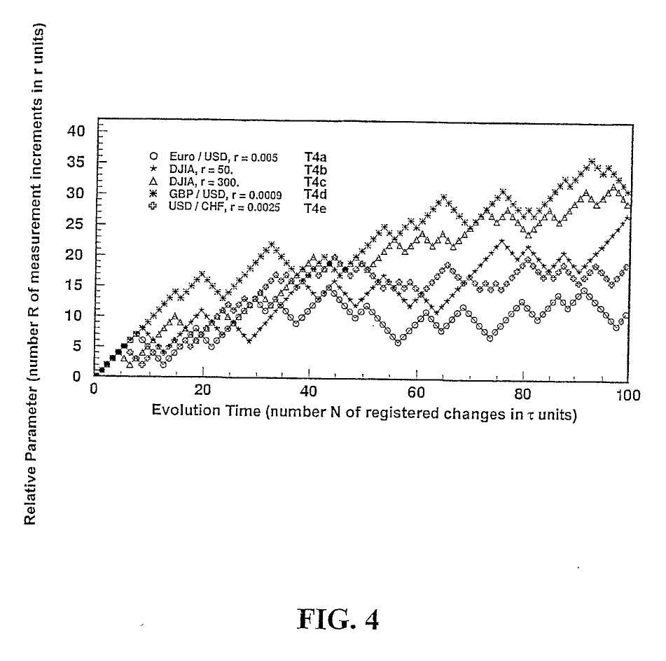

FIG. 4 shows the image obtained as a result of the superposition of 5 different trajectories in Increment-Change Space. The image may include trajectories which appear to be unrelated with one another: the trajectory T4a represents, using open circles, the ratio EUR/USD, with r=0.005, i.e. the first 100 points of FIG. 2 starting from initial point P1a the date of which is Aug. 10, 1998; the trajectory T4b represents, using stars, the Dow Jones Industrial Average or DJIA index, with r=50, from October till November 1999; the trajectory T4c represents, using open triangles, the DJIA index, with r=300, from the moment of DJIA birth until 1998; the trajectory T4d represents, using asterisks, the GBP/USD ratio, with r=0.0009, from May 21 till May 27, 2001; the trajectory T4e represents, using open crosses, the USD/CHF ratio, with r=0.0025, from May 17 until May 31, 2001. The starting points of each of the trajectories T4a-T4e are aligned (for example, set to zero) in Increment-Change Space, where the relative parameter (expressed as the number of measurement increments r) along the vertical axis is equal to one-half of the wavelength, as expressed by equation (1), and the evolution time measurement unit is the value τ (redefined as τ=r/c as expressed in connection with equation 2 above). A slope (e.g., velocity), which may be set at will, was chosen as “c” for all the graphs thus aligned. Some of the trajectories pointed downwards in real space; accordingly, their direction was reversed before alignment.

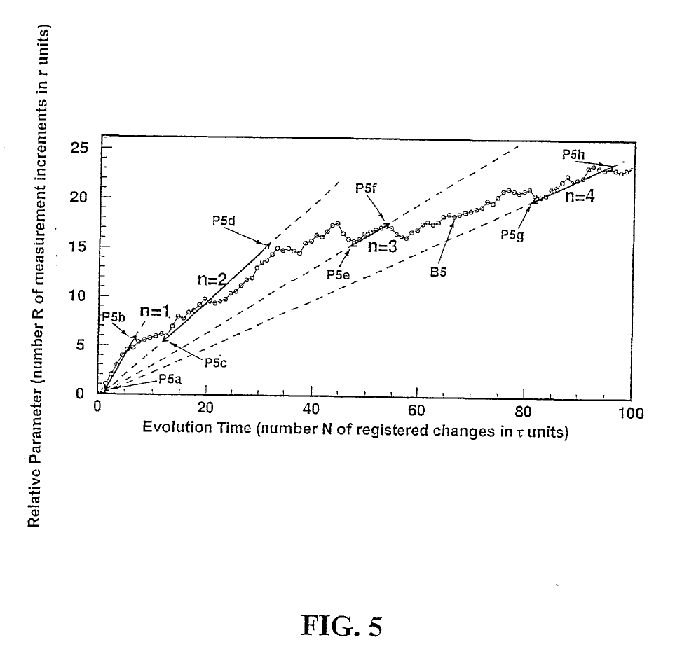

FIG. 5 shows a beam-average curve B5 determined by averaging, at each point along the Evolution Time axis, the value of the Relative Parameters (i.e. the average of the vertical coordinates) of the five trajectories T4a to T4e shown in FIG. 4. The term “average” as used herein is the value defined substantially or approximately by calculating an arithmetical mean. For example, the average may be a weighted mean (where the weighting coefficients may be user-defined). However, any other averaged value may be applied that does not distort the idea of the method. In general, the beam-average may be obtained for any type of trajectory in Increment-Change Space by calculating the average of parameter for each Evolution Time. The indication of velocity quantization in accordance with expression (10) may be observed in the beam-average curve B5 of FIG. 5. For example, the beam-average curve B5 seems to have sections P5a-P5b, P5c-P5d, P5e-P5f and P5g-P5h that follow to quantum lines n=1, 2, 3, and 4, respectively.

The foregoing indicates the existence of the effect of quantization of velocities in a randomly composed (i.e. incoherent) beam of trajectories. Although the trajectories may be completely unrelated and refer to different market parameters and historical periods, by operating in dimensionless Increment-Change Space, we have been able to combine in one beam what seemed to be incompatible. For example, the beam B5 includes the DJIA index trajectory which has been in existence almost a century, the EUR/USD currency correlation over a period of about a year and a half, and a brief spurt, lasting only a few days, of the British pound in relation to the dollar. Particular attention is drawn to this factor to emphasize the importance and universality of the results obtained.

Since recognition of the quantum effect is a cornerstone of the theory developed herein, let us cite here the results of another experiment. Let us verify the existence of the quantum effect in a coherent beam of trajectories, as opposed to the quantum effect in a randomly composed beam of trajectories (e.g., the trajectories T4a to T4e as shown in FIG. 4). The coherent beam may be obtained by splitting one initial trajectory into a beam of two or more coherent trajectories. According to the properties of Increment-Change Space, all points on the real parameter curve that differ from the last registered change by a value less than the measurement increment r will have the same formal coordinate in Increment-Change Space. One curve in real space may be transformed into two or more trajectories in Increment-Change Space, (e.g., to create a coherent beam of trajectories each with the same wavelength λ as expressed in equation (1) and coinciding points of emission). To create the two or more trajectories, it is sufficient merely to “shift” the measurement starting point on the parameter axis of the real curve by a value less than the measurement increment r.

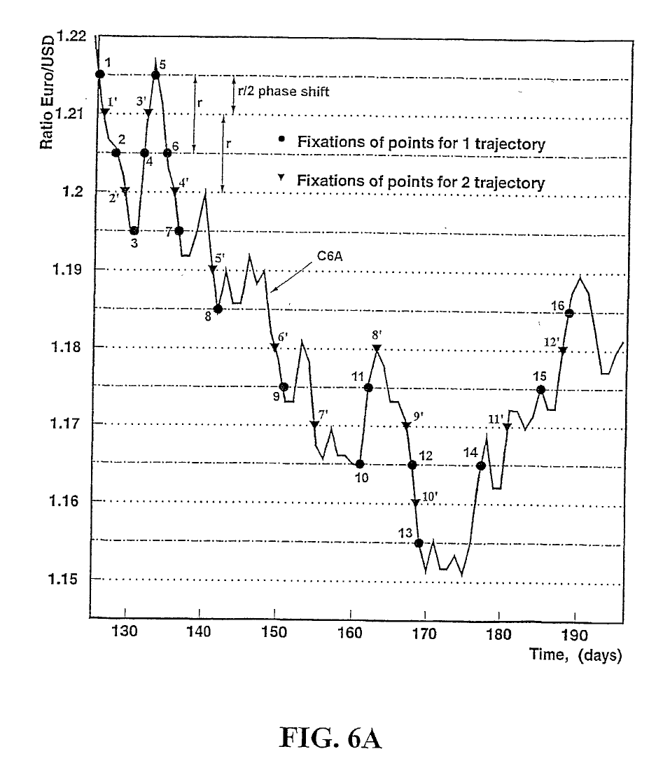

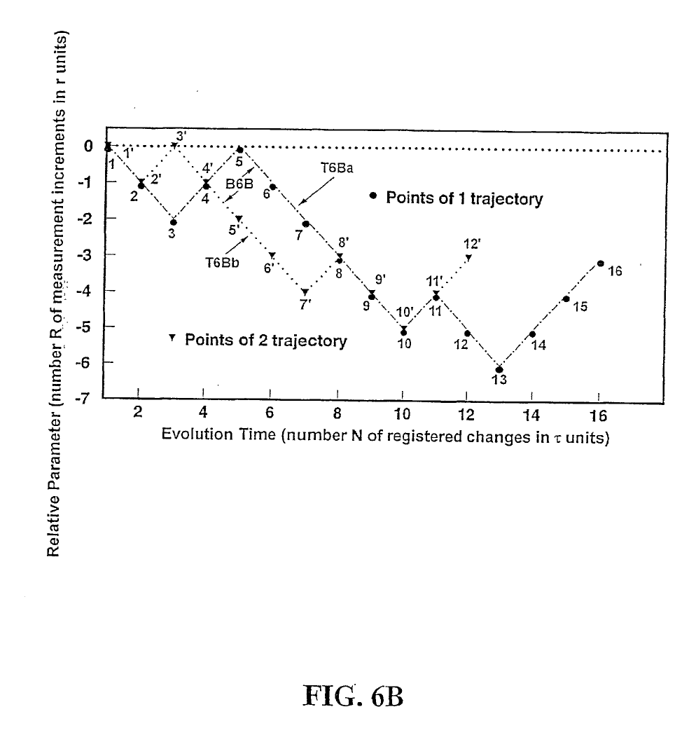

An example of the aforementioned beam transformation will now be described with reference to FIGS. 6A and 6B. A coherent beam B6B in FIG. 6B consisting of two trajectories T6Ba and T6Bb may be obtained by transforming one real curve C6A as shown in FIG. 6A, where r was given the value 0.01 and the first trajectory T6Ba is phase shifted by r/2 with respect to the second trajectory T6Bb. For example, the round dots 1-16 in FIG. 6A are used to plot the first trajectory T6Ba in FIG. 6B and the triangular points 1′-12′ in FIG. 6A are used to plot the second trajectory T6Bb in FIG. 6B.

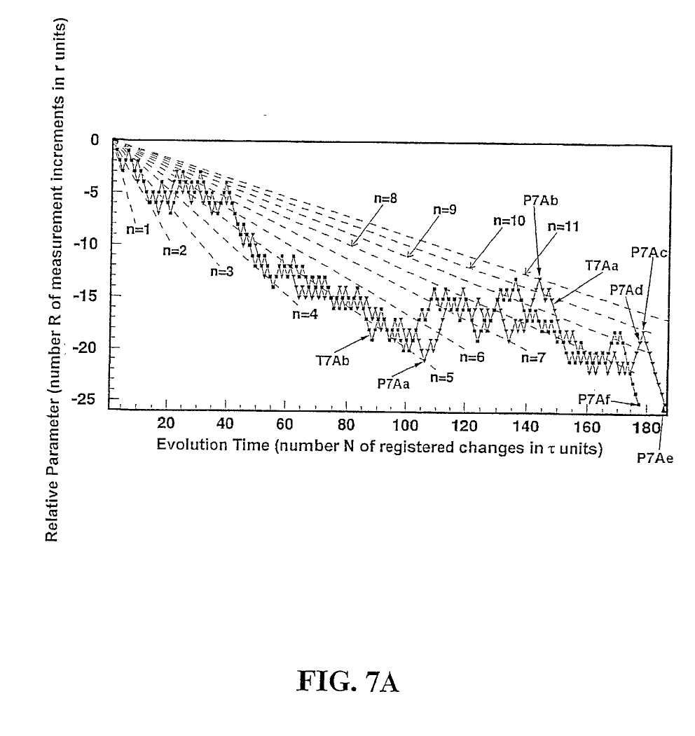

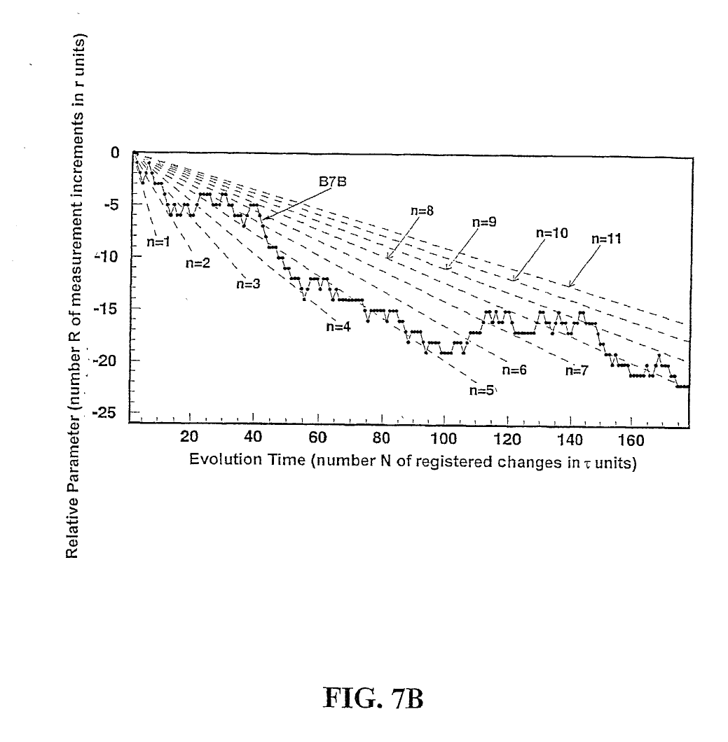

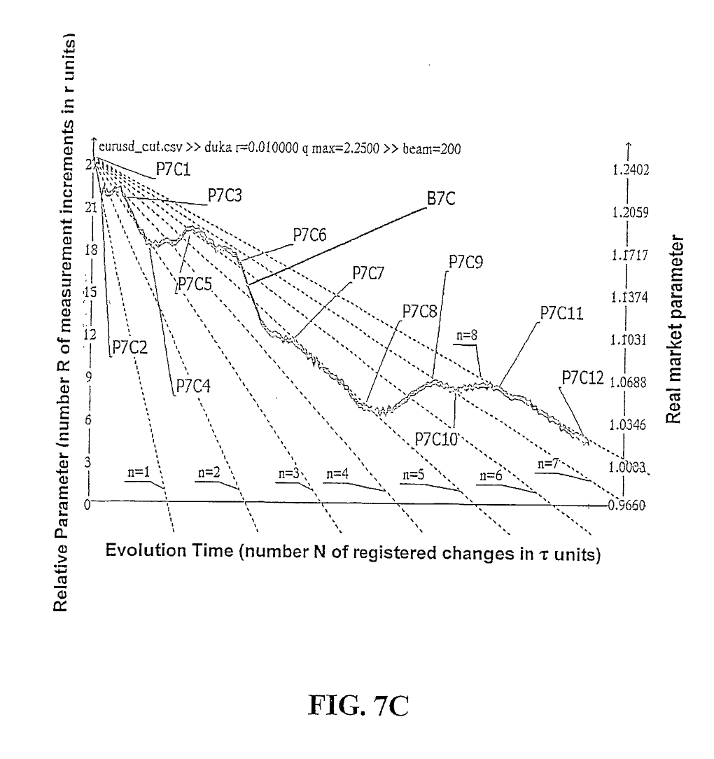

FIG. 7A shows the beam transformation with a phase shift of r/2, as explained above, of the section P1a-P1b of the real curve shown in FIG. 1. Quantum lines n=1 to n=11 have been superimposed on the two trajectories T7Aa and T7Ab. It is interesting to observe that many of the market rebounds occur when the trajectories touch or are very close to the quantum lines (e.g., at points P7Aa, P7Ab and P7Ac), which would tend to confirm the existence of a quantum effect.

FIG. 7B shows a beam-average curve B7B which is the “center of mass” (or the average relative parameter) of the two trajectories T7Aa and T7Ab of FIG. 7A. The beam-average curve may be obtained for any number of trajectories. The meaning of “beam-average curve”, “center of mass of trajectories” and “trajectory of center of mass” are absolutely equivalent. As was mentioned above, the quantum effect has a statistical character. From the averaging of two trajectories, it may be seen that the quantum directions roughly followed by the beam-average curve B7B are the quantum lines n=5 and n=8.

FIG. 7C shows a beam-average curve B7C for 200 trajectories obtained by the phase shift r/200 for the same section P1a-P1b of the real curve shown in FIG. 1. Thus, FIG. 7C differs from FIG. 7B only by the number of trajectories used and the manner of presentation. FIG. 7B is drawn mainly to explain the principle of construction of a beam-average curve while FIG. 7C is a real example of a graph that may be used in market analysis. The curve of FIG. 7C may be obtained by using software written in accordance with the teachings contained herein. The quantum effect may be seen much more clearly in FIG. 7C than in FIG. 5. The difference may be explained by two factors: a greater number of trajectories used (e.g., two hundred trajectories used in FIG. 7C in comparison to only five used in FIG. 5), and the independent character of the trends (see FIG. 4) used for averaging in FIG. 5. Due to the much smoother character of the fluctuations, the curve B7C subsequently follows the quantum line n=1 in the section P7C1-P7C2, line n=3 in the section P7C3-P7C4, line n=6 in the section P7C5-P7C6, line n=5 in the section P7C7-P7C8, briefly follows line n=7 in the section P7C9-P7C10 and, finally, the line n=8 in the section P7C11-P7C12.

The Increment-Change Space transformations discussed earlier were generally based on a fixed measurement increment r of the market parameter (e.g. price, exchange rate, etc) axis (or parameter-normalization). However, one may also affect a transformation in time-normalized Increment-Change Space as set forth in expressions (iv)-(vi) that may be described as follows: if the market parameter (e.g. stock market closing price) is measured at equal time intervals τ (for example one day), then irrespective of real rise or fall of the market parameter, the corresponding rise or fall in Increment-Change Space is set at a constant value r. In other words, only the direction of change of the market parameter is reflected. If the change is a rise, the fixed value r is added to the preceding Y coordinate; if it is a fall, the fixed value r is deducted. Of course such a transformation will considerably distort the price axis, but what matters is that motion in such space must obey the same universal laws.

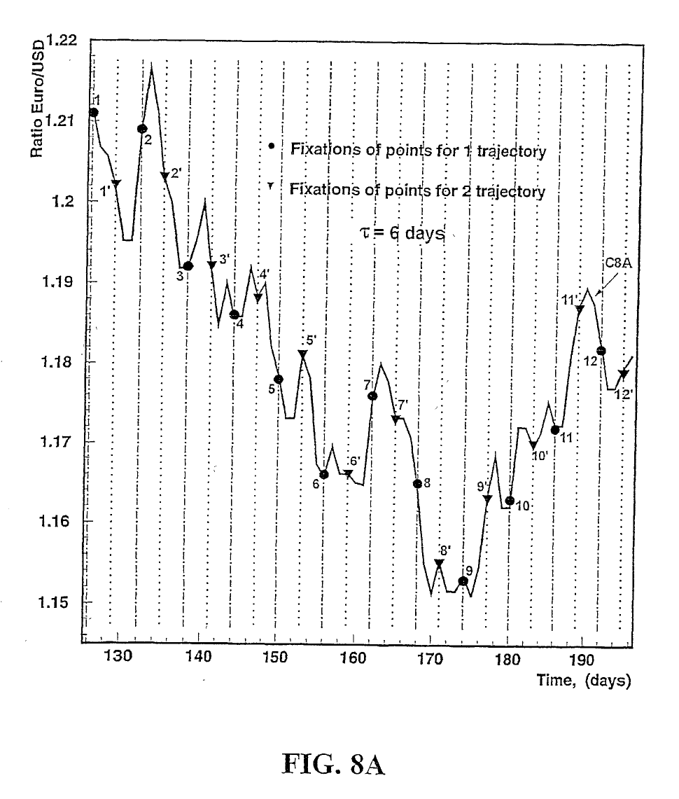

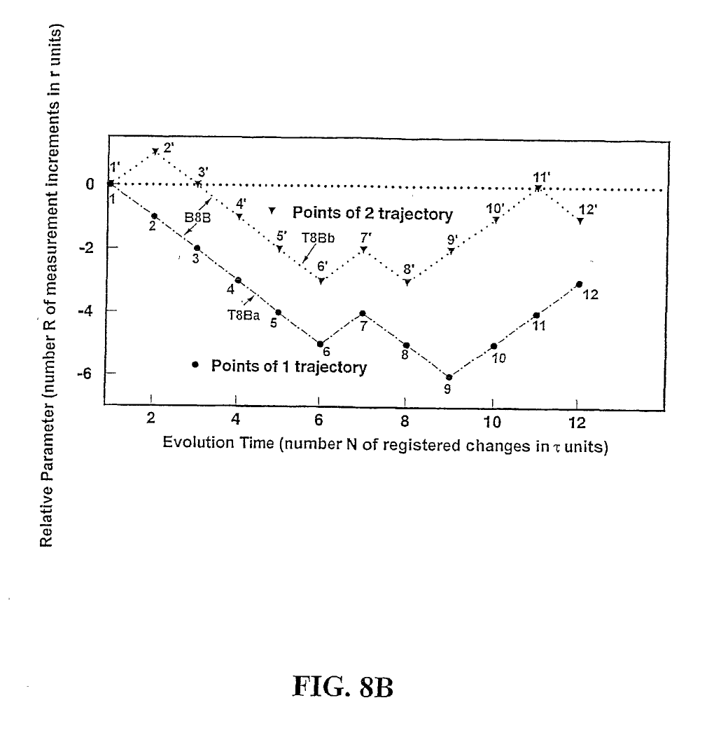

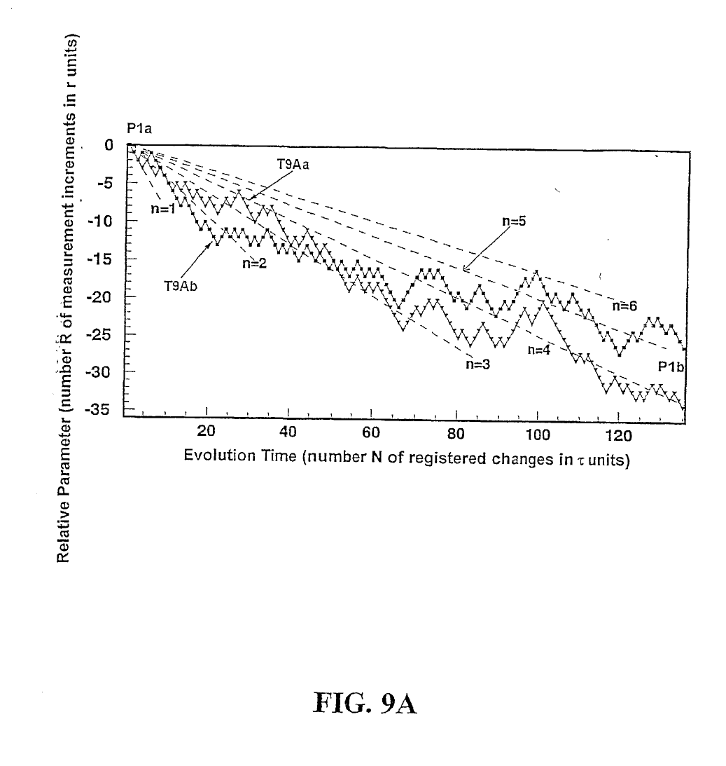

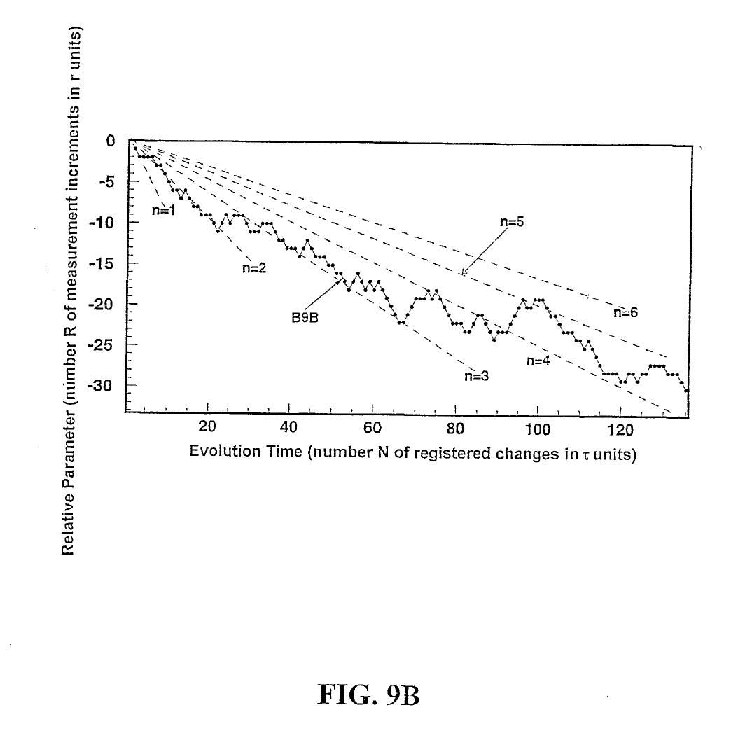

In the same way, as shown in FIGS. 9A, 9B, it is possible to verify the existence of the quantum effect in a coherent beam of trajectories in time-normalized Increment-Change Space. It is possible to transform a curve in real space into two or more trajectories in time-normalized Increment-Change Space, i.e. to create a coherent beam of trajectories with the same wavelength λ as expressed in equation (1) and coinciding points of emission. It is sufficient merely to “shift” the starting point on the time axis of the real curve by a value less than the measurement increment τ. An example of such splitting may be described by referring to FIGS. 8A and 8B. The coherent beam B8B in FIG. 8B is obtained by transforming the real curve C8A shown in FIG. 8A, where τ is given the value 2 days and the phase shift is τ/2 (one day), into two trajectories T8Ba and T8Bb as shown in FIG. 8B. Points 1-12 in FIG. 8A are used to plot the first trajectory T8Ba in Increment-Change Space, while points 1′-12′ in FIG. 8A are used to plot the second trajectory T8Bb in Increment-Change Space as shown in FIG. 8B.

FIG. 9A generally shows a time-normalized transformation as explained above, as applied to the section P1a-P1b of the real curve shown in FIG. 1. The second trajectory T9Ab is phase-shifted by τ/2 with respect to the first trajectory T9Aa. FIG. 9B shows a beam-average curve B9b which is the “center of mass” (i.e. the average relative parameter) of the two trajectories T9Aa and T9Ab of FIG. 9A. It may be clearly seen in this example that the beam-average curve B9B follows closely, along sections thereof, respective quantum lines n=1 to n=4.

II. 2) Uncertainty of the Increment-Change Space Trajectory Coordinate: Parameter Localization AR

FIG. 10 shows a trajectory T10 corresponding to the section P1a-P1b of the real curve of FIG. 1 after transformation in parameter-normalized Increment-Change Space with a measurement increment of r=0.02. The experimental parameter localization ΔRexp for the trajectory section from point P10-1 to point P10-13 is generally measured as the vertical distance between the support (lower) and resistance (upper) lines S10a and R10a, respectively. The support and resistance lines S10a and R10a are generally parallel to the average trajectory line T10a and pass through the outermost points P10-5 and P10-7, respectively. In a similar manner, the experimental parameter localization ΔRexp for the whole trajectory from point P10-1 to point P10-36 may be measured as the vertical distance between the support and resistance lines S10b and R10b, respectively. The support and resistance lines S10b and R10b are generally parallel to the average trajectory line T10b.

The average trajectory lines T10a and T10b are linear approximations of the trajectory sections P10-1 to P10-13 and P10-1 to P10-36, respectively. The average trajectory lines T10a and T10b may be obtained, for example, by using the least square method. The equation of the average trajectory line T10a may be expressed in slope-intercept form as Y=−0.55 X+0.15 and the equation of the average trajectory line T10b may be expressed as Y=−0.28 X−1.88. The slopes of the average trajectory lines T10a and T10b are thus equal to −0.55 and −0.28, respectively. As discussed above with reference to FIG. 3, where the maximum velocity c is chosen as equal to 1, the slope of a line in Increment-Change Space is equal to 1/n. We can therefore conclude that, for example, 1/n is equal to 0.55 for the average trajectory line T10a and to 0.28 for the average trajectory line T10b.

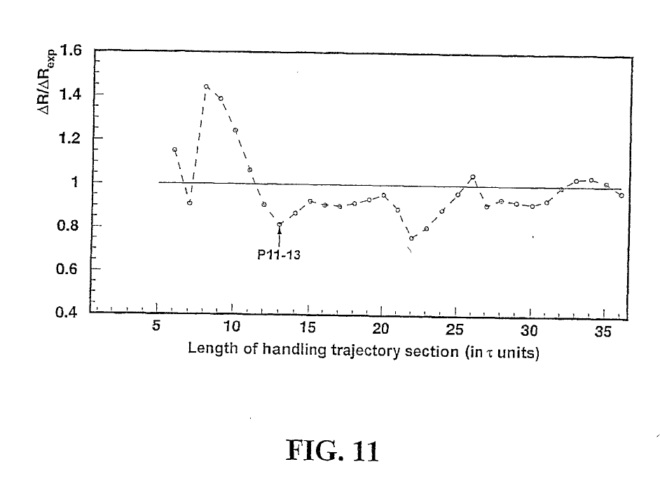

FIG. 11 shows the ratio ΔR/ΔRexp of the trajectory shown in FIG. 10 for respective trajectory sections defined from the initial point to each current point. To avoid a hundred percent uncertainty which arises according to expression (21) for n=1, the first five current points are not taken into account. The parameter localization error ΔR is calculated according to expression (19) where r is the known measurement increment, q is given the value of the square root of 2, and the quantum number n is the inverse value of the slope of the average trajectory line of the corresponding section of trajectory of FIG. 10. For example, to determine n for point P11-13 in FIG. 11 the trajectory section from origin to point P10-13 in FIG. 10 is taken and the average trajectory line T10a is obtained as described above. The slope of this line gives the value of 1/n. For each measurement point along the Evolution Time axis, ΔRexp is measured as the vertical distance between the support and resistance lines, determined as mentioned above. As may be seen in FIG. 11, the ratio ΔR/ΔRexp varies around the level of unity, except in the field of low quantum numbers n where these variations are, as expected, greater than at the right-hand portion of the graph, where the value of n increases. Therefore, for the determination of ΔRₑₓₚ, we excluded the first five points of FIG. 10 for which there is an uncertainty. Due to the fact that ΔR/ΔRexp varies around the level of unity for n>>1, ΔR/ΔRexp≈1 and we can conclude that expression (19) is met.

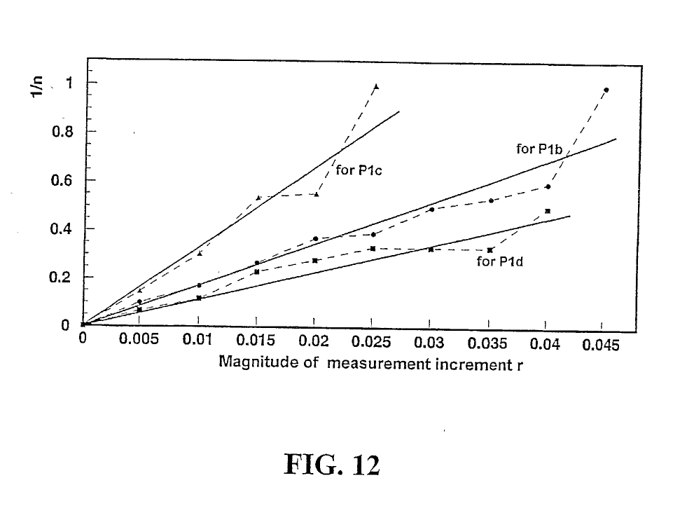

FIG. 12 shows the value of 1/n for points P1b, P1c and P1d of the real curve of FIG. 1 after transformation into Increment-Change Space. 1/n is given by the slope of the respective solid lines extending from the origin of the Increment-Change Space chart to points P1b, P1c and P1d, respectively, for transformations of the section P1a-P1b of FIG. 1 for different values of the measurement increment r. As can be seen from the graph, in the range 1/n<0.4 (or n>2.5), there is a substantially linear relation between 1/n and r, which confirms the theoretical properties of Increment-Change Space discussed above, in particular the validity of expression (23), whereby r·n remains substantially constant independent of the value of r used. As could be expected, in the area 0.4<1/n<1 (or 1<n<2.5), the errors are increasing. Precisely because, according to expressions (20) and (21), any assertion in Increment-Change Space can be correct only with some degree of uncertainty, we used the symbol “≈” instead of “=” in expressions (22) and (23).

III. Development of Information Analysis Tools

III. 1) Possible Market Development Directions

Let us now consider one of the main practical applications of the theory developed hereinabove. As is well known, forecasting of market trajectories is the principal concern of millions of investors. The information analysis tools described hereafter may assist investors in improving forecasts.

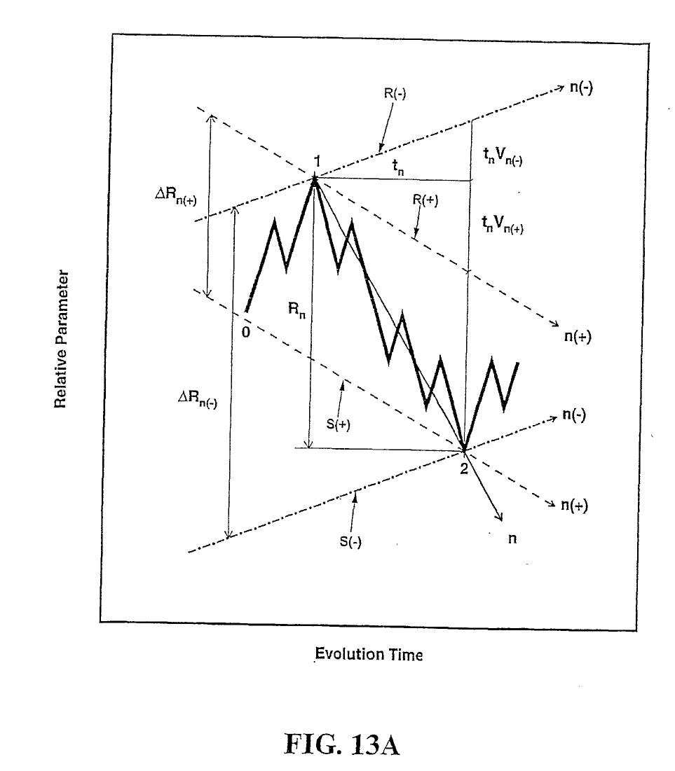

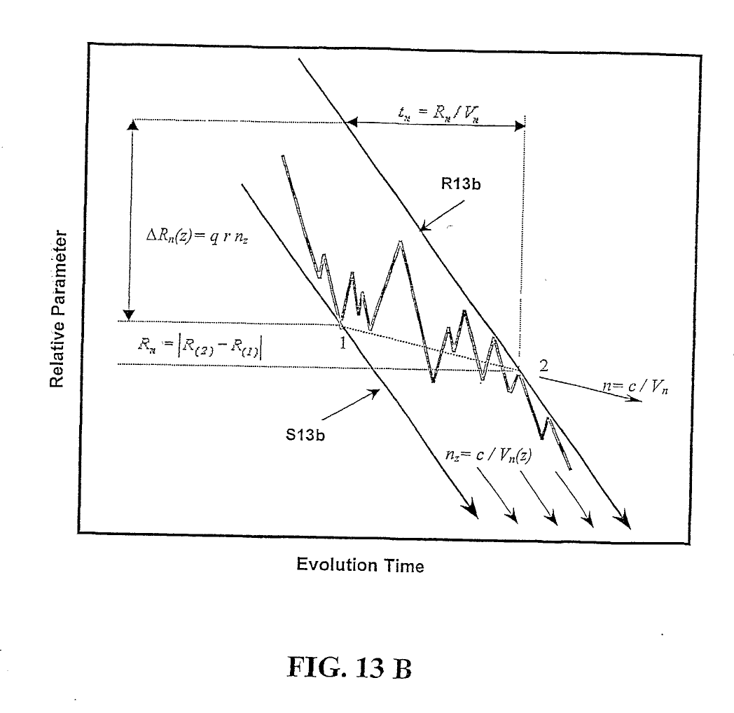

FIG. 13A shows a model section of a trajectory in Increment-Change Space. Let us suppose that marked rebounds occurred at points 1 and 2 and that we wish to determine the direction in which the trajectory will proceed. Let us also presume that point 2 is the base point through which the support line of a new trajectory will later be drawn—either in the same direction as n but with a higher quantum number (i.e. at lower velocity) n(+), or in the direction opposite thereto n(−). Point 1 generally determines the resistance lines R(+), R(−) of the future trajectory, parallel to the corresponding support lines S(+), S(−). The next step is determining the quantum numbers (i.e. the velocities or the slopes) for the two possible directions of the future trajectory.

From a formal point of view, the problem may be defined as follows. For two different points in Increment-Change Space, we need to determine the quantum numbers of the trends localized by the support and resistance lines passing through those points. According to the terms of the problem, these trends should be physically compatible with the space coordinates of the pair of points.

Let us designate the quantum numbers of these trends as n(+) and n(−), where (+) corresponds to the trend pointing in the same general direction as n, while (−) designates the opposite general direction. As shown in FIG. 13A, localization of such trends may be determined in the following way:

ΔRₙ₍₊₎=Rₙ−tₙVₙ₍₊₎ (28.1)

ΔRₙ₍₋₎=Rₙ+tₙVₙ₍₋₎ (28.2)

By the introduction of a coefficient z=±1, these two equations may be reduced to a general form.

ΔRₙ₍ₓ₎=Rₙ−ztₙVₙ₍ₓ₎ (29)

Here z=1 takes into account the same direction as the 1→2 trajectory, while z=−1 takes account of the opposite direction. Furthermore, Rₙ=|R₍₂₎−R₍₁₎| and tₙ=t₍₂₎−t₍₁₎, where (R₍₁₎,t₍₁₎) and (R₍₂₎,t₍₂₎) are the coordinates in Increment-Change Space of points 1 and 2, respectively. Given that tₙ=Rₙ/Vₙ, and bearing in mind expressions (10) and (19), the condition of physical compatibility may be expressed as the following compatibility equation:

qₓrnₓ²=Rₙ[nₓ−zn] (30)

Here qₓ means that in a general case q may depend on the direction. Subsequently, to simplify the designation of qₓ we propose to use the same value of q for both directions. At the moment, for the sake of simplicity we accept qₓ=q=\sqrt{2}. It should be noted, however, that this may not always be a sound assumption—a problem that will be treated in detail further on. In view of the foregoing, the solution of the physical compatibility equation may be expressed as follows:

$${n}_{z} = \frac{{R}_{n}}{2 qr} \pm \sqrt{\frac{{R}_{n}^{2}}{4 {q}^{2} {r}^{2}} - \frac{{zR}_{n} n}{qr}} \qquad ( 31 )$$

The result obtained from this calculation has important practical implications. First of all, there cannot be more than three compatible solutions. For ease of distinguishing between these three possible Increment-Change Space trends, the inventor has assigned a certain letter to each. First, at z=−1 (direction opposite to 1→2) a solution always exists and it is always the only one, as the second solution is negative and, by definition, nₓ>1. Thus, at any value of n and Rₙ there is a possible future trajectory in the opposite general direction which endeavors to reverse the current trajectory. The quantum number n(−)=n_{α} of such a trajectory may be determined in the following manner:

$${n}_{α} = \frac{{R}_{n}}{2 qr} + \sqrt{\frac{{R}_{n}^{2}}{4 {q}^{2} {r}^{2}} + \frac{{R}_{n} n}{qr}} \qquad ( 32 )$$

We shall call this solution “alpha”. But if we are considering solution (31) at z=1, (e.g., looking for the quantum number of the trajectory moving in the initial general direction), then several variants present themselves. The variants may be determined for positive values of the expression standing under the root. If

$$n < \frac{{R}_{n}}{4 qr} \qquad ( 33 )$$

then there are two solutions, which we shall call “beta” with a high quantum number, and “gamma” with a lower number, respectively.

$$\begin{matrix}{n}_{β} = \frac{{R}_{n}}{2 qr} + \sqrt{\frac{{R}_{n}^{2}}{4 {q}^{2} {r}^{2}} - \frac{{R}_{n} n}{qr}} & ( 34 ) \\ {n}_{γ} = \frac{{R}_{n}}{2 qr} - \sqrt{\frac{{R}_{n}^{2}}{4 {q}^{2} {r}^{2}} - \frac{{R}_{n} n}{qr}} & ( 35 )\end{matrix}$$

A single positive trend solution, which we shall call “abc”, exists when the “beta” and “gamma” Increment-Change Space trajectories coincide. Such a coincidence generally takes place at n=Rₙ/4qr and may be expressed as follows.

$${n}_{abc} = 2 n = \frac{{R}_{n}}{2 qr} \qquad ( 36 )$$

In the event of the “abc” solution the expression for n_{α} may be simplified. Substitution of the condition n=Rₙ/4qr in equation (32) gives the following result.

$${n}_{a} = 2 n ( 1 + \sqrt{2} ) = \frac{{R}_{n}}{2 qr} \cdot ( 1 + \sqrt{2} ) \qquad \text{(36.1)}$$

This n_{abc} solution also has a special physical meaning, which we shall consider later.

On the other hand, a positive trend solution cannot exist if

$$n > \frac{{R}_{n}}{4 qr} \qquad ( 37 )$$

In general, for all expressions (28-37) the following occurs:

$${R}_{n} = \vert {R}_{( 2 )} - {R}_{( 1 )} \vert and n = \frac{c ( {t}_{( 2 )} - {t}_{( 1 )} )}{{R}_{n}} \qquad ( 38 )$$

Here (R₍₁₎,t₍₁₎) and (R₍₂₎,t₍₂₎) are the coordinates in Increment-Change Space of points 1 and 2, respectively. In addition, for any ni it is assumed that

$${n}_{i} = \frac{c}{{V}_{i}} , where i is : z , a , β , γ , abc , etc . \qquad ( 39 )$$

In the context of putting into effect the idea of constructing physically compatible trends, it is generally useful to indicate some other possible scenarios of calculating the quantum numbers. For instance, it might be useful to consider a situation where—unlike in the case shown in FIG. 13A—the base points 1 and 2 are located at opposite support and resistance lines respectively as shown in FIG. 13B.

By analogy to formula (28.2), the compatibility equation may be formulated as:

ΔRₙ₍ₓ₎=−−Rₙ+tₙVₙ₍ₓ₎ (40.1)

The difference from (28.2) consists in the minus sign placed before Rₙ. In light of equation (40.1) we can also rewrite the general form of the compatibility equation (29) as follows:

ΔRₙ₍ₓ₎=±Rₙ±tₙV_{n(z)} (40.2)

Here any combination of plus and minus corresponds to one of the scenarios of the compatibility problem.

After substituting all the necessary variables into (40.1) we obtain the solution in the following form:

$${n}_{z} = - \frac{{R}_{n}}{2 qr} \pm \sqrt{\frac{{R}_{n}^{2}}{4 {q}^{2} {r}^{2}} + \frac{{R}_{n} n}{qr}} \qquad \text{(40.3)}$$

The solution “with a minus sign” may be discarded at once, given that n is a positive figure. On the other hand, n must (by definition) be greater than unity. Hence all solutions less than unity may be ruled out. Bearing in mind the above, we arrive at the following definitive formulation of the solution for a same-direction alpha trend:

$${n}_{a +} = - \frac{{R}_{n}}{2 qr} + \sqrt{\frac{{R}_{n}^{2}}{4 {q}^{2} {r}^{2}} + \frac{{R}_{n} n}{qr}} \qquad \text{(40.4)}$$

It is very interesting to consider what happens to the alpha-solutions when Rₙ=0. This corresponds to a situation where both base points are located on the same horizontal straight line. The substitution of Rₙ=0 in (40.4) as well as in (32) leads to the disappearance of the addend in front of the root and of the first addend under the root. As for the second addend under the root, since n=c/Vₙ=(tₙ/τ)/(Rₙ/r) after the substitution and cancellation of Rₙ, it is precisely this addend that determines the solution for symmetrical alpha trends:

$${n}_{{a}_{o}} = \sqrt{\frac{{t}_{n}}{q τ}} \qquad \text{(40.5)}$$

Now we must look into what it actually means if a solution to the physical compatibility equation is or is not available. According to formal logic, the absence of a solution should be interpreted as the impossibility of drawing two parallel lines through points 1 and 2 of the trajectory of FIG. 13A or FIG. 13B, which may be taken as, respectively, the resistance and support lines R, S of a trajectory in Increment-Change Space. One solution means that such a pair of straight lines can be drawn in only one way. But the availability of two or three solutions means that these lines can be drawn in two or three different ways, respectively. It may be stressed once again that the criterion adopted for the possibility of drawing the parallel lines localizing the trajectory through points 1 and 2 in FIG. 13A is the applicability of the Increment-Change Space uncertainty relation according to expression (19). The total number of variants of the Increment-Change Space trajectory limited by lines passing through points 1 and 2 is then at most three and at least one. Of several competing solutions—alpha, beta and gamma—real motion must, in the long run, choose only one and even then merely in order to reject that direction, too, in favor of a new one (or new ones). The motion thus described may be an infinite sequence of rectilinear trajectories, constantly passing into one another, which are limited in space by certain bands.

Without going too deeply into the causes of the change in the Increment-Change Space trajectory which, in formal language, can be reduced to some impact on the corresponding wave packet or particle, we will concern ourselves here only with those physical states into which a motion occurring prior to an impact can be transformed after that impact. According to this approach the Increment-Change Space motion represents a broken line of a certain thickness (depending on the slope) where disturbing shocks of the market correspond to the kinks between the rectilinear sections, while “inertial” motion is represented by the rectilinear sections, which may also be very short. In a sense, this concept may even be considered as somewhat deterministic. Indeed, if the future stems from the known past, then this is really so. It is also a symmetrical concept, in that our knowledge of the “future” makes it possible to restore the “past”. As with any quantum theory, however, the determination generally goes only as far as the limits of the correlation of uncertainties, beyond which all certainty disappears without a trace.

The correspondence between the approach we have described and the experimental data may be illustrated by the following examples.

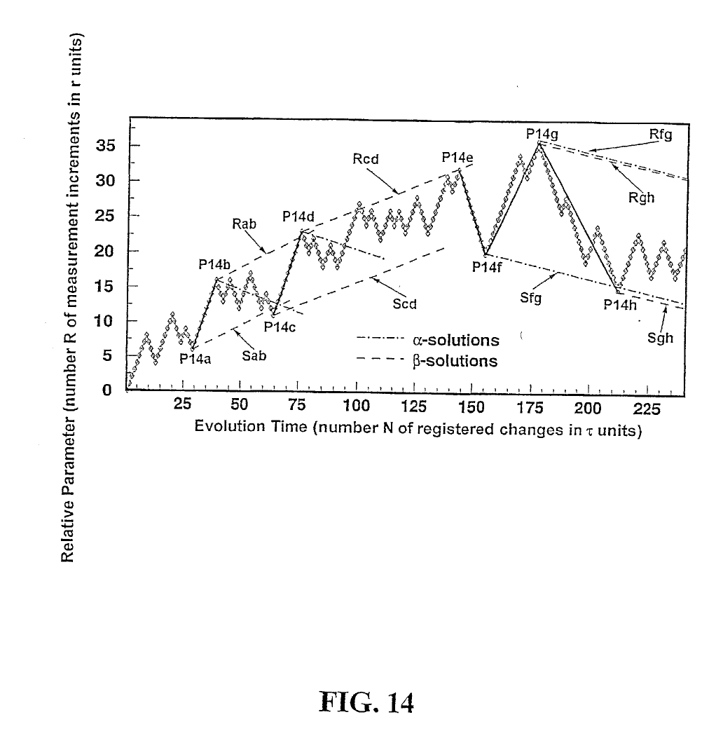

FIG. 14 shows the behavior of the DJIA index, from October 1999 to January 2000, in Increment-Change Space for r=50 on which are superimposed support and resistance lines calculated according to expression (31) for each of the selected sections P14a-P14b, P14c-P14d, P14e-P14f, P14f-P14g and P14g-P14h. More particular “alpha” and “beta” support and resistance lines are calculated according to expressions (32) and (34), respectively. One can see that the solutions to the compatibility equation, which is constituted by two parallel lines creating the resistance and support lines, limit the trajectory development over a certain length. For example, the beta-solution Rab, Sab of the P14a-P14b section limits the trajectory development from point P14a up to point P14d, and the beta-solution Rcd, Scd of the P14c-P14d section defines the trajectory development starting from point P14c up to point P14e. It is clearly seen that for similar trend sections such as P14a-P14b and P14c-P14d, the corresponding beta-solutions are comparable. It is interesting to note that at points P14g and P14h, the alpha-solution Rfg, Sfg of the previous section P14f-P14g passes into the beta-solution Rgh, Sgh of the next section P14g-P14h. Thus, the general behavior of the current trajectory section is defined by the previous one.

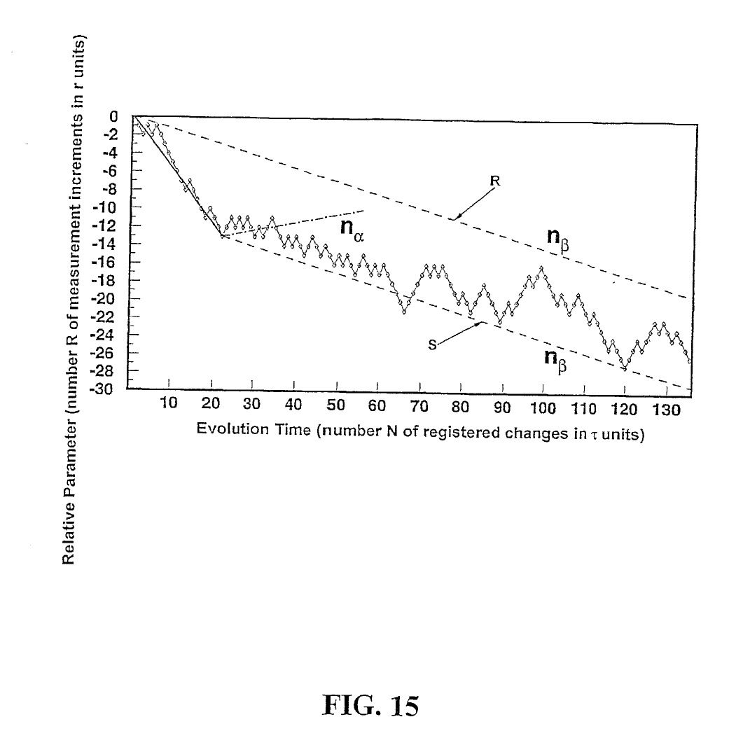

FIG. 15 shows the section P1a-P1b of FIG. 1 after time-normalization transformation in Increment-Change Space, where the time measurement increment is r/c=2 days. It is clearly seen that the beta-solution R, S limits the trajectory development.

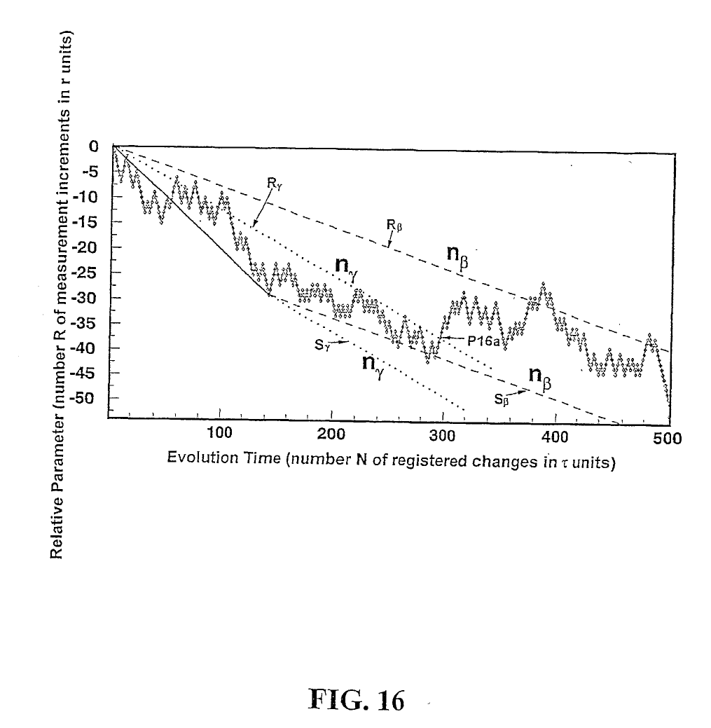

FIG. 16 shows the development of the same section P1a-P1b of FIG. 1 after parameter-normalization transformation in Increment-Change Space with the measurement increment r=0.005. FIG. 16 provides an example of trajectory development inside the beta S_{β}, R_{β} and gamma S_{γ}, R_{γ} solutions. It can be seen that when the trend overcomes the resistance line R_{γ} of the gamma-solution, at point P16a, its development is restricted by the beta-solution support line S_{β}.

FIGS. 14 to 16 confirm the usefulness of the solutions of the physical compatibility equations to determine resistance and support lines of market parameter trajectories in Increment-Change Space. These solutions may be used to perform the analysis of evolution of the market parameters.

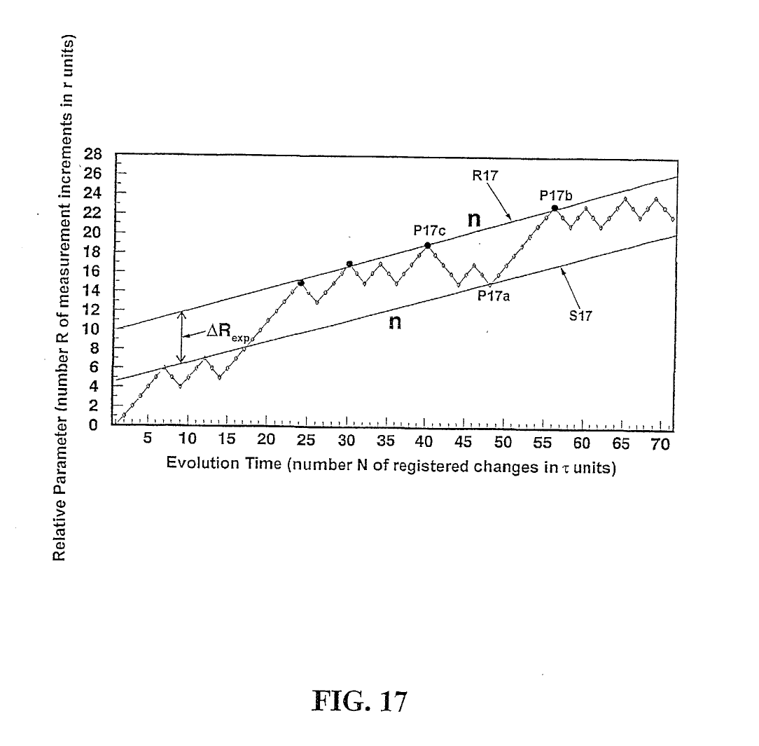

In general, if a certain straight line is the support or resistance line of the Increment-Change Space trajectory, then a parallel resistance or support line, respectively, must also exist, due to the Increment-Change Space uncertainty relationship (expression 19). The distance between this second border line and the first one may be determined by this relationship. In other words, when drawing any straight line we must also draw, at the appropriate distance, its parallel traveling companion. Consider for example FIG. 17 which shows the DJIA Increment-Change Space trajectory from the moment of its “birth” until the year 2000, where r=500. The resistance line R17 is clearly visible at the top. Points used to draw this resistance line are marked by black circles. The support line S17 can be drawn by plotting a line parallel to the resistance line R17 and passing through the point P17a. Moreover, as mentioned above, for each registered change along the Evolution Time axis, the experimental parameter localization ΔR is approximated as the vertical distance between the support and resistance lines. The experimental parameter localization may be determined by measuring the vertical distance separating the support and resistance lines S17 and R17 in FIG. 17, which in this example is approximately equal to 6 r units (in other words 3000 DJIA points). The value n is the inverse of the slope of the average trajectory line (or of the support S17 and resistance R17 lines) of the whole trajectory of FIG. 17. One can see in FIG. 17 that t17b−t17c=56−40=16 and R17b-R17c=23−19=4, such that n=16/4=4. Considering the equation (19) according to which ΔR≈qrn, if we choose q as the square root of 2, the product qrn of this example, as expressed in r units, is equal to \sqrt{2}×4, which is approximately 6 r units. This therefore corresponds to the experimental value of ΔRₑₓₚ. Thus, we can conclude that the equation (19) expressing the uncertainty relation as ΔR≈qrn is once again experimentally verified in this example.

III. 2) General Market Development Equation Curve

Let us analyze more closely the development of the parameter from its historical starting point towards the future. As the measurement increment r is a finite value, then in all cases where the value R of the market parameter is less than the measurement increment r (i.e. R<r), the parameter will simply be equal to zero. The first registered change for the observer will occur at the moment when the value of the parameter exceeds the value of the measurement increment r. We have already seen an example of such a graph in FIG. 17, which shows the evolution of the industry of the Dow Jones Industrial Average (DJIA) from its birth until the year 2000. Everything that happened before R=r=500 is, in our case, concentrated in one point, R=0. The graph therefore represents the complete history of the development of the Dow Jones Industrial Average to the year 2000.

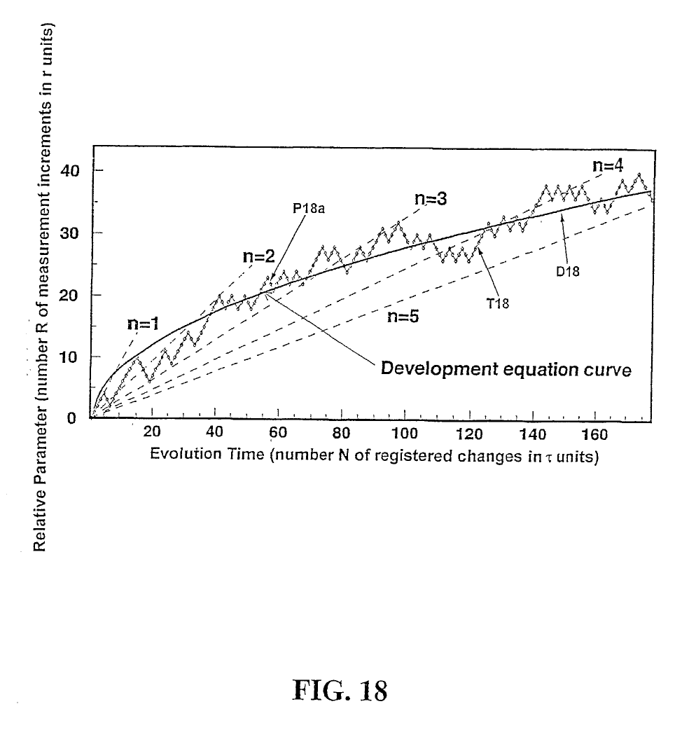

FIG. 18 shows the DJIA in parameter-normalized Increment-Change Space for the measurement increment r=300. The trajectory of the curve is slightly more detailed than in FIG. 17, where r=500. One may observe from this graph how the US economy, in the process of its development, gradually “worked off” the quantum magnitudes of its velocity. When the two graphs of FIG. 17 and FIG. 18 are compared, notwithstanding their different scales (r=500 for FIG. 17 and r=300 for FIG. 18), it may be noted that they are approximately the same. Despite the non coincidence in real space-time, approximately equal parameter values measured in the number of units of the measurement increment r correspond to the same number of registered changes in Increment-Change Space. In other words, in dimensionless Increment-Change Spaces, the two trajectories coincide to some extent. Thus, on both graphs, the value of the relative parameter R corresponding to the Evolution Time coordinate 56 is R=23 r (see point P17b in FIG. 17, and point P18a in FIG. 18), although in real space, these points are decades apart from each other, and their real DJIA values differ almost by a factor of two.

The notion of similarity forms part of the possible consequences of the universality principle. Different-scale graphs of the same trajectory in dimensionless Increment-Change Spaces should roughly coincide.

If the number of particles in the beam is increased to infinity, the trajectory of its center of mass will ultimately approximate a relatively smooth trajectory. Let us define the equation of this trajectory R(t) as the ideal equation of development. Considering the theoretical trajectory of part of a trajectory in Increment-Change Space as shown in FIG. 13A. Let the starting point of the trajectory coincide with point 1, while point 2 is any point of the trajectory R(t). A single line localizing the parallel trajectory can be drawn through point 2 such that this localizing line will coincide with the tangent of the trajectory R(t). It was shown earlier that a single parallel solution with the quantum number n_{abc} can exist only subject to meeting the following condition (see expression (36)).

Rₙ=4qrn (41)

According to the demonstration made with connection to FIG. 3, n=tₙ/Rₙ (the maximum velocity c, which is chosen at will, being equal to unity), where tₙ is expressed in τ units and Rₙ is expressed in r units. Expressing n as (t/τ)/(R/r) in equation (41), one obtains the following expression for the equation of the development equation curve in Increment-Change Space:

$${( \frac{R}{r} )}^{2} = 4 q ( \frac{t}{τ} ) \qquad ( 42 )$$

The thick solid line D18 in FIG. 18 is the development equation curve of the trajectory T18 in accordance with equation (42). The differentiation of the equation of development at any point of the trajectory leads, in its turn, to the ABC-solution according to expression (36). That is to say that at any point of the development equation curve D18, the tangential line is in fact the quantum line corresponding to the quantum number n_{abc}. The physical significance of the ABC-solution is thus determined. The trajectory of the ABC-solution coincides with the line tangential to the ideal equation of development. Since real motion is always “scattered” around the ideal trajectory, in practice one rarely has only one solution of the compatibility equation for the parallel trajectory. Nevertheless, even where two solutions are formally available, it is useful for the analyst to draw an additional n_{abc}-line because it is unlikely to be breached. The n_{abc}-line is generally steeper than the beta-line but less steep than that of the gamma-solution.

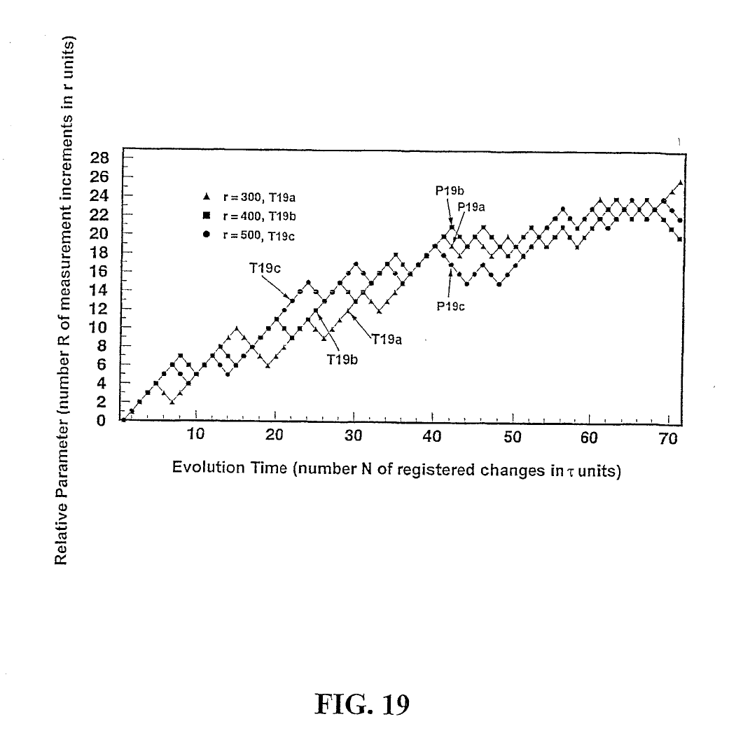

In FIG. 19, three Increment-Change Space DJIA trajectories T19a, T19b and T19c with different measurement increment r values (r is equal to 300, 400 and 500, respectively) are superimposed on one another in Increment-Change Space. This image is a good illustration of the universality principle. At this stage, we may confirm experimentally that the curve of averaged trajectories really tends towards the development equation curve according to expression (42).

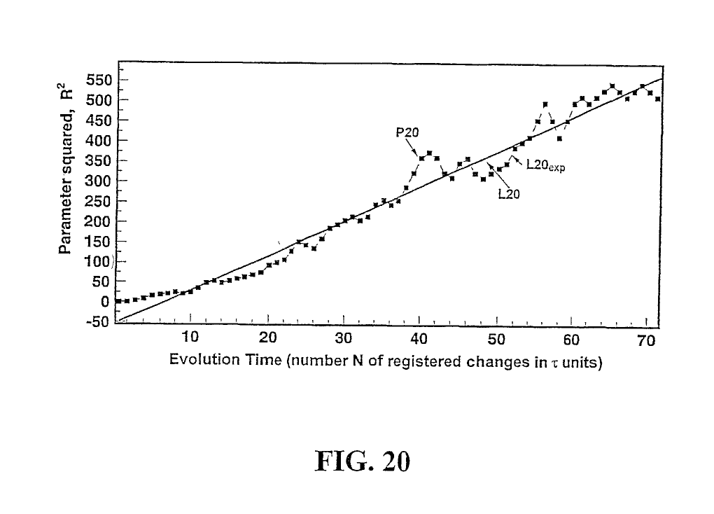

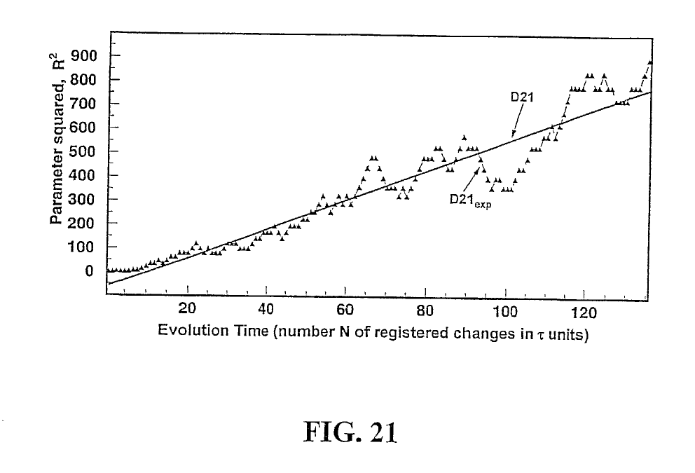

The graph in FIG. 20 shows the mean relative parameter R squared (R²) of the three trajectories T19a, T19b and T19c represented in FIG. 19 as a function of Evolution Time. By way of example, the R value of point P20 at time coordinate 41 in FIG. 20 is equal to the average value of the three R values of the three points P19a, P19b and P19c in FIG. 19, which is equal to (19+21+16)/3=18.7. The value of R² is thus approximately 350, as shown in FIG. 20. By considering the relative parameter R squared (i.e. R²) as a function of evolution time, the development equation curve according to expression (42) becomes a straight line, as shown in FIG. 20. It is clearly seen that the experimental development line L20ₑₓₚ represented by black squares (calculated in the same manner as for point P20 discussed above), fluctuates around the ideal development line L20, showing a good enough agreement between the experimental and ideal development equation curves. It is important to mention that the development equation curve can be obtained for a section of the trajectory starting from some initial point of the trend in real space. For example the graph of FIG. 21 shows the time dependence of the relative parameter squared R² for the beam-average curve B9b shown in FIG. 9B obtained for section P1A-P1B in FIG. 1. The difference between FIG. 21 and FIG. 20 is that the starting point in FIG. 21 is not the historical starting point of the parameter contrary to FIG. 20. The line D21 is the ideal development equation curve as calculated according to equation (42). Once again, a good enough agreement is observed between the experimental development equation curve D21ₑₓₚ and the ideal development equation curve D21.

IV. Practical Examples of Information Analysis Tools

IV. 1) General Principle

In the following section, we shall describe, with reference to examples, a method of processing and analyzing market parameters. The method may be implemented by means of computer software, to aid an analyst, investor or trader (hereinafter “user”) in making a buy, hold, sell and many other types of decisions and recommendations. Computer software for practical implementation of the invention may ensure iterative processes of the following type:

Request (instruction) by the user

Request handling and information delivery in appropriate graphical or any other form suitable for the user

New request (instruction) by the user on the basis of analysis or received information

Handling of the new request (instruction) . . .

etc, which will end, for example, when the user judges he has enough information to make a buy, hold, sell or other type of decision and/or recommendation; or when the user achieves the understanding of the market situation that he judges sufficient for his purposes. The user has the possibility to exit from the process at any time.

The iterative process in accordance with the present invention may allow the user to accumulate useful information concerning the evolution of a market parameter being analyzed. For example, the iterative process may be used to accumulate intersection signals of the trajectory with a support line and/or a quantum line. Due to the fact that several signals in favor of the same market direction may reinforce each other, the risk of human error when making a final decision may be minimized.

The success of market forecasting or speculation significantly depends on the way in which the aforementioned technical analysis method is applied. It relies on the capacity of an experienced user to make a judicious choice of analysis parameters, such as the measurement increment r and the coefficient q, and of the analysis tools to be used, such as the support and resistance lines, the development equation curve, the creation of a beam and the quantum lines. The user then performs a pertinent analysis of the plotted results in a relatively short time since the market is continually changing, to continue analysis or to make a decision.

The information and information analysis tools available to the user that may be acted upon with the assistance of a data processing system and software, may comprise the following:

a real market data database

a method of transformation of a real curve to a trajectory in Increment-Change Space

one or more trajectories in an Increment-Change Space Chart

a data smoothing or noise fluctuations filtering method

a method for determining and/or selecting and/or proposing the q coefficient (in relation with the compatibility equation)

a method for determining and presenting (e.g., by superposition) on the Increment-Change Space Chart analysis lines such as support and resistance lines, quantum lines, development equation line(s), beams, beam-average curves, the fastest trajectories and variations thereof.

The above information and information analysis tools are discussed below.

IV. 2) Information and Information Analysis Tools

IV.2)-a The real market database

First of all and before starting the analysis, the user will need to select the real market database on which he wishes to work so that it will be as close as possible to an “ideal” database. The term “ideal database” should be understood as a continuous record of all without exception consequent values of the changing parameter, which is also free of any defects, recording gaps, distortions, etc . . . In practice, it is difficult to fulfill this criterion, even if such fulfillment is seen as the ultimate goal. Moreover, with the purpose of reducing the amount of data stored and transmitted over data networks, a simplified (shortened) format may be used in practice. Stock market information for quoted share prices, stock market indices, exchange rates etc. are commercially available from various suppliers of such data, via the internet or by direct telecommunication access to the suppliers' database server network.

In case of stock market data, a set of periodical characteristic prices may be often chosen as the appropriate format, for example the quotes for open, close, minimum and maximum prices. Also indicated is the standard duration of the interval, a start time or end time of the interval, and sometimes the volume of transactions within the interval. To provide speed of data transmission and storage of the data in a compact format the real time axis may be divided into standard intervals and the intervals characterized with a finite set of parameters.

If the dynamics of the parameter change in real time is represented in such a reduced format (which is generally true for the vast majority of cases), it is generally not an ideal method of representing and displaying data. Gaps between characteristic points (for example, between maximum and minimum prices) may define the degree of error attributable to the data. The degree of error may define the smallest meaningful value for the choice of the measurement increment r.

IV.2)-b The transformation step in Increment-Change Space

The user can select the measurement increment r himself (e.g., the measurement increment may be accepted as a user input), seek an automatic recommendation on the optimal measurement increment from the data processing system, or select the measurement increment while being guided by a recommendation from the system. As has been discussed above, the optimal values of r are generally greater than or equal to the average amplitude of the difference between the maximum and minimum quotes within a standard time period. In one example, the system may be configured to add all average amplitudes relating to the selected data with which the user is working, divide the resulting answer by the number of added terms, and communicate the calculated average difference amplitude to the user to assist in optimizing the choice of r, in particular to assign a value greater than the average amplitude. Once the measurement increment r is determined, the transformation of the real curve to a trajectory in Increment-Change Space is generally affected as previously described herein. The trajectory may be referred to as the “main trajectory”. The real curve may also be transformed into a beam of two or more trajectories and, if desired, the beam-average curve thereof may be determined, which may be superposed on the main trajectory, and/or analyzed separately. There are many ways of presenting the aforesaid transformation in Increment-Change Space, and of processing the main trajectory or the trajectories of a beam to provide useful information for analyzing market trends, as shown in the examples described below.

IV.2)-c Example of processing a beam of trajectories in Increment-Change Space

A particularly useful way of analyzing the trend of a market parameter is by splitting the main trajectory into a beam of trajectories, and plotting the center of the mass of the trajectories to generate a beam-average curve, as previously discussed in relation to FIGS. 7A, 7B and 7C. Additionally, the fastest beam particle trajectory, which may be obtained as described below, may be generated and presented.

By way of example, if we refer to the beam consisting of two trajectories T7Aa and T7Ab (e.g., as shown in FIG. 7A), one observes that the end points P7Ae, P7Af of the trajectories generally have different values along the Evolution Time axis while having the same relative parameter. If we plot a beam consisting of a larger number of trajectories, the end points of the trajectories will generally have the same coordinate on the relative parameter axis and differing coordinates on the Evolution Time axis. The beam trajectories thus gradually “slide apart”. The fastest trajectory is the trajectory (e.g., the trajectory T7Ab in the example of FIG. 7A) that reaches the end coordinate (which will often be the current market parameter value) in the shortest evolution time interval. The slowest trajectory (e.g., the trajectory T7Aa in the example of FIG. 7A) generally reaches the end coordinate in the longest Evolution Time interval.

If the general trend of a beam is downwards, as is the case in FIG. 7A, the point P7Ad of the slow trajectory with the same Evolution Time coordinate as the last point P7Af of the fast trajectory is generally above the last point P7Af. If a beam consists of more than two trajectories, then all other trajectories will also cross the vertical straight line passing through the Evolution Time coordinate of the end point of the fast trajectory above the point P7Af.

This property of the end point of the fast trajectory may also be expressed differently: the end point of the fast trajectory is generally positioned in front of the center of mass of the beam's trajectories. This means that in case of a downward trend, the end point of the fast trajectory is generally located below the beam's center of mass and for an upward trend, the end point of the fast trajectory is usually above the center of mass of the beam trajectories. This property of the fast trajectory may be applied to identify the direction of the trend.

To facilitate a user's decision making, it is generally useful to display (e.g., on a computer monitor) the beam-average curve and the fast trajectory of the beam. It is important to mention that the trajectories may exchange their relative positions (e.g., the fast trajectory becoming the slow one and vice versa).

In the case of a large number of trajectories, the position of the trajectories in the beam relative to each other may be constantly changing. For example, the faster trajectories may slow down, while the slower ones accelerate. For this reason, the fastest trajectory may be re-defined for each registered change in the parameter. In general, for the currently identified fast trajectory, the coordinate of the end point of the trajectory is determined, the end point is plotted on the graph and the operation repeated for every new change in the parameter. The resulting sequence of end points generally forms a special trajectory that is generally the fastest of all the beam trajectories. At the same time, the fastest trajectory may also be used as a main trajectory for developing support and resistance lines, quantum lines and development equation curves. However, the main property of the trajectory is that it is always “ahead” of the beam's center of mass and can thus be used to more clearly identify market trend direction changes, for the purposes of market forecasting.

IV.2)-d Real data noise fluctuations Filtering out Process

Independently of the choice to proceed on with one or more trajectories in Increment-Change Space, it may be useful for the purpose of facilitating analysis to smooth out the peaks of the trajectories. A data noise fluctuations filtering out process may be performed with a traditional method of technical analysis known as the “moving average”. However, moving average analysis generally averages, for example, an N number of subsequent quote values to derive only one average point and therefore shortens the resulting trajectory by N-1 points. Instead of the traditional method and according to the properties of Increment-Change Space, a smoothing method may be applied that uses the moving average method with the averaging period equal to two points. In general, the important advantage of smoothing is the application to two points (e.g., taken with any user-defined weight coefficients) in Increment-Change Space. At the same time, the smoothing method itself is not so important. In practice, any smoothing procedure (not only the moving-average method) may be used. Consequently, the resulting trajectory is not shortened. Generally a one-off averaging does not result in the desired elimination of “roughness”. The method of smoothing may be repeated a number of times by averaging each subsequent result. The repetitions may be stopped when the curve becomes sufficiently smooth to permit the analysis of the resulting image. The corresponding number of times smoothing was applied may be considered as optimal (sufficient). By experience of the inventor, the optimal number of times that smoothing is applied generally lies between about four and about ten.

IV.2)-e The q Coefficient

Correct definition of the coefficient q is an important practical task, since the value of q influences inter alia the value of the parameter localization AR (or the relative parameter distance between the support line and the resistance line). The value of q was defined above as being approximately equal to the square root of two. In practice, the choice of the value for q allows certain deviations from this value.

First, it is necessary to point out that q is approximately equal to a constant which is close to the indicated value only in the case where the user has available an “ideal” database. This condition may be presumed to be met.

Experience of the inventor suggests that in the case of sufficiently large values of the measurement increment r, for example, when r is considerably larger than the average amplitude that characterizes the degree of error of the curve in real space (e.g., in the case of an ideal database), better results may be achieved by using any value of q between the square root of two and two, and sometimes slightly greater.

The choice of the concrete value of q from the optimal range depends on the trading tactics preferred by the user. For example, the solutions for the physical compatibility problem generally lead to the decrease of the quantum number, and thus an increase in velocity, with the rise of q. Therefore, by choosing the value of q closer to the upper limit of the optimal range (e.g., q=2), a more “aggressive” picture may be presented (e.g., the support and resistance lines may be steeper). This means that with large q, the user will receive an earlier signal to change his trading position. Thus, the problem of choosing a precise value of q may become to some extent the issue of trading tactics.

There are two more factors to take into account while assigning a value for q. The greater the value of q, the lower the probability of having beta- and gamma-solutions (see expression (34) and (35) for tracing support and resistance lines). In the proximity of q=2, beta and gamma solutions are rarely available, facilitating significantly the interpretation of support and resistance lines being drawn on the graph because the user obtains only one alpha-solution. This makes the information on the Increment-Change Space simpler and less ambiguous for the user, which facilitates the process of making a trading decision. Secondly, when the maximum value is taken for q, the equation curve generally becomes the external envelope of all trajectories, such that the parameter trajectory which is touching the development equation curve or coming in proximity to the curve provides a strong trading decision signal.

Due to the fact the ideal conditions essentially concerning the original database are not always achievable, it is useful to put forward a practical method for deriving the value of the q coefficient under conditions that are not ideal.

Let us look at the interpretation of the q coefficient in the general case. The value q was introduced above as a number coefficient while deriving the uncertainty relationship (19). The uncertainty relationship may be used to define parameter localization in Increment-Change Space, which equals the vertical distance between the support and resistance lines of the trajectory. If the support and resistance lines pass through the outermost points of the trajectory, the parameter localization corresponds to the maximum value of q. In turn, such interpretation of q means that the development equation curve becomes the outermost envelope of the trajectory in Increment-Change Space. From this, it follows that experimentally, we may derive the maximum estimation for the value of q from the equation of the development equation curve, under the condition that the development equation curve is drawn from the initial point of the trajectory through the outermost point of the trajectory. Accordingly, the following method for deriving q may be considered as the easiest one. The user chooses a pair of points on the graph such that one is the point corresponding to the start of the trend, and the other, a point of the trajectory. Then, the user enters into the computer the coordinates of these points (e.g., using a mouse cursor), after which the value of q may be calculated employing the expression (41) as q=Rₙ/4rn, where Rₙ signifies the difference between the coordinates of the selected points on the parameter axis, r is the measurement increment and n is the quantum number defined by equation (38). After defining the value of q for several points, the resulting solutions may be compared to choose the maximum one.

The proposed method may be automated. To this end, the section of the trajectory in Increment-Change Space may be scanned. A point on the graph may be identified, which is the starting point of the data (for example the origin of the graph). Subsequently, the identified starting point is considered in pair with every remaining point that belongs to the trajectory. For each such pair, a q coefficient is calculated as described above. The resulting solutions may be compared and the one with the maximum value is chosen. Then, the next point is fixed and then paired with all remaining points. For each pair, the q coefficient, is determined. These values are then compared to chose the one with the highest value, and then compared with the maximum of the preceding cycle, after which the absolute maximum for both cycles is chosen. The iterative process may be continued until all possible combinations of points have been examined and the maximum value of the q coefficient has been selected.

The discussed examples of methods for defining the coefficient q are generally based on the principle that any pair of identifiable points in one-dimensional space unambiguously defines the development equation curve, starting from the first point and passing through the second one. And, as we know, the value of the q coefficient enters the equation of development. Let us consider another example. Using the mouse cursor, the user may fix the point of the start of the trend and the position of the second point through which the development equation curve is automatically drawn. The coefficient q corresponding to such curve may be depicted next to the curve. By manipulating the mouse, the user may alter the position of the development equation curve, for example, such that it passes through the outermost point of the trajectory, and then fix the corresponding value of q.

To complete the series of examples of defining the maximum value of the q coefficient in practice, we have to consider one other interesting method. Let us refer once again to the equation of development (41). The expression includes the quantum number n, that corresponds to the line connecting the two points selected from the graph. If n=1, we have q=Rₙ/4r. From this, it follows that to calculate the maximum value of q, all that is needed is to find the longest rectilinear segment on the graph depicting the changing parameter in Increment-Change Space and divide its vertical projection by four. Under rectilinear segment, we mean a rectilinear part of the trajectory without any “turns” (e.g., a segment of the trajectory exactly from one turn to the next turn).

Thus, several different examples have been demonstrated of practically defining the maximum value of the q coefficient. Let us repeat again, that the convenience of choosing the maximum value is due to three factors. Firstly, the support and resistance lines plotted according to the highest value of q will also be characterized by the highest velocity, so that they will produce the earliest signal of the change in the trajectory's general direction after being intersected by the trajectory. Secondly, the compatibility equation is left only with the family of alpha-solutions which significantly facilitates the process of making a trading decision. Thirdly, when the maximum value is chosen for q, the development equation line becomes the external envelope of any trajectory. This implies that if the trajectory crosses the development equation curve, a strong trading decision signal is given.

To determine an average value of q, it is possible to approximate the trajectory with the average development equation curve passing through the “middle” of the points of the trajectory. The terra “middle” allows for multiple interpretations. There is a plentitude of standard methods for minimizing the approximation error but the standard least square method is preferred.

IV.2)-f Information Analysis Lines

After the definition of the q coefficient, the user may enter the coordinates of two points which, in the user's opinion, belong to the support and resistance lines. After receiving these coordinates, a system in accordance with the present invention may automatically determine the angle of inclination of a line joining the two points, which provides the quantum number n used to calculate and plot the support and resistance lines. As soon as the trajectory exits the corridor defined by the support and resistance lines, the crossing of which can be interpreted as a signal of a trend reversal and as a possibility to change the trading position, the user can enter into the system a new pair of points to plot new support and resistance lines.

Nevertheless, the signal of a trend reversal obtained as a consequence of the fact that the parameter change trajectory exits the corridor defined by the plotted support and resistance lines, as just mentioned, is not always sufficient information to take a reasonable decision. The support and resistance lines constitute the main analysis lines, but to reduce the risk of error, the user may seek additional confirmation signals. In other words, the user may consider other analysis lines, since several signals of the same trend generally reinforce each other.

The user can collect complementary information by superimposing complementary analysis lines, for example quantum lines, development equation curves, beam-average curves, fast trajectories, etc., on the main analysis lines.

The system may be configured in such a way as to allow the user to enter the coordinate of the point from which quantum lines are to be drawn. If the user detects a rebound of the trajectory from a quantum line, according to the conclusions drawn from the theory, the rebound may be a signal that the market parameter may change direction, (e.g., a signal of a trend reversal). In general, the number of the quantum lines may be set at a default by the system or may be requested (or entered) by the user.

The development equation curve is generally of great importance. As mentioned above, when the q parameter is chosen so that it is equal to a maximum value, the development equation curve becomes the external envelope of any trajectory. This implies, for example, that the trajectory should not cross the development equation curve. Therefore, the user may anticipate, for example, that the market parameter is likely to make a downward correction after an upward movement makes the trajectory reach the development equation curve.

The user may, in one example, enter the coordinate of the point from which the development equation curve is to be drawn. Optionally, the user may choose to draw the fastest beam trajectory and the beam-average curve and also carry out the smoothing of any trajectory.

IV. 3) Practical Examples

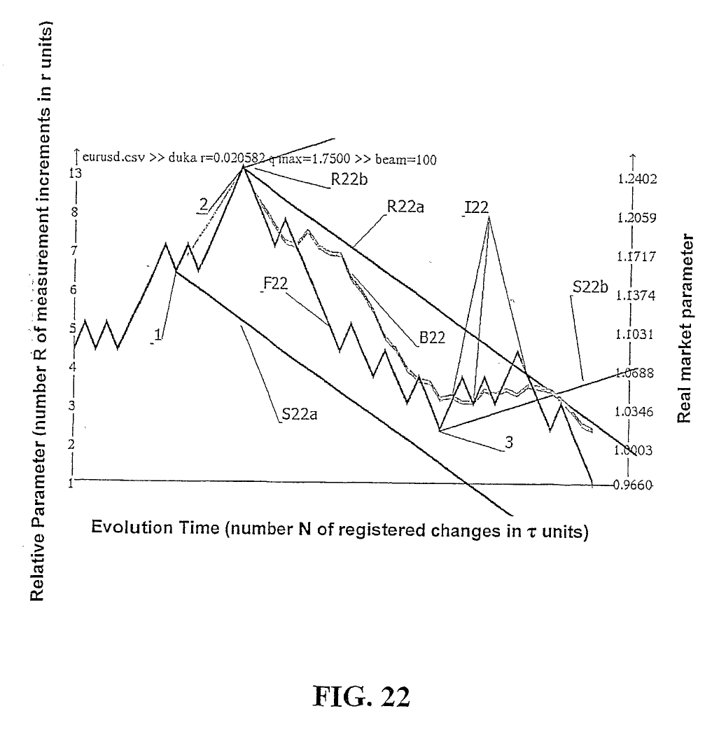

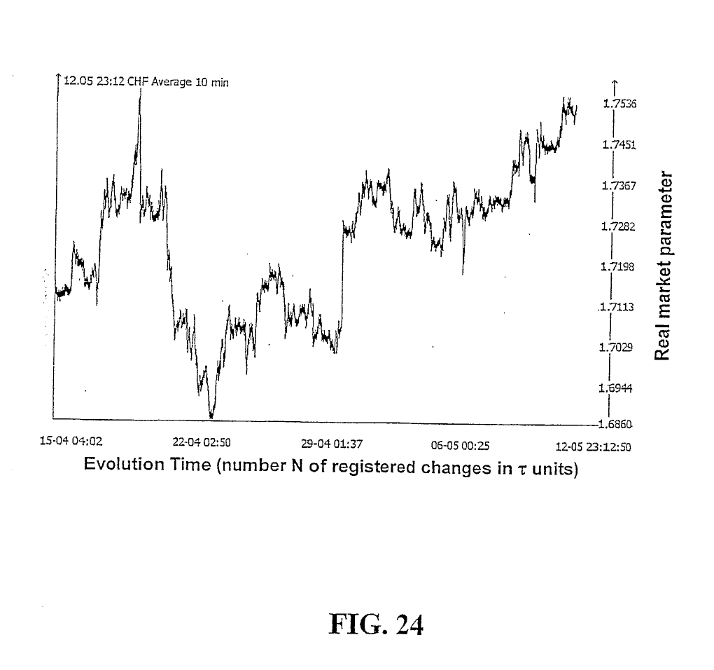

In order to further illustrate how the above-described information analysis tools may be used in practice by a user (an analyst, trader or investor), two further practical examples will now be discussed with reference to FIGS. 22 to 25. FIGS. 22, 23 and 25 generally represent a computer screen view of charts in Increment-Change Space, while FIG. 24 generally shows real market data. On FIGS. 22 to 25 the horizontal axis represents Evolution Time, the vertical axis on the right is the relative parameter in Increment-Change Space, while the vertical coordinate on the left is a real market parameter.

FIG. 22 is a chart in Increment-Change Space of the Euro/USD rate shown in FIG. 1 for the period Apr. 20, 1998 to Jan. 28, 2000 after (i) transformation with a measurement increment of r=0.0206, (ii) further splitting into a beam and (iii) subsequent determination and plotting of the fastest beam trajectory F22 and the beam-average curve B22. As previously discussed, in the case of a downward trend, the fastest trajectory is generally located below the beam-average curve, and vice-versa, for an upward trend.

While applying such a property of the fastest trajectory to identify the direction of the trend the user can simultaneously employ other tools such as support and resistance lines of the trend, the development equation curve, etc. To this end, the user decides upon the value of the coefficient q that will be used for the calculation of the distance between the support line and the resistance line.

The value of q that ensures the simplest interpretation of graphical information is qₘₐₓ—the maximum of all values of q corresponding to a specific range of analyzed data as previously described. It is important to keep in mind that the support and resistance lines plotted according to this value of qₘₐₓ are generally characterized by a high velocity, so that the lines will produce an early signal of the change in the trend direction after being intersected by the trajectory in the Increment-Change Space. Moreover, the choice of the maximum value qₘₐₓ generally results in that the compatibility equation is left only with the family of alpha-solutions, which facilitates the process of making a trading decision. Also, the development equation curve generally becomes the external envelope of any trend trajectory, which implies that the parameter change trajectory should not cross the development equation curve.

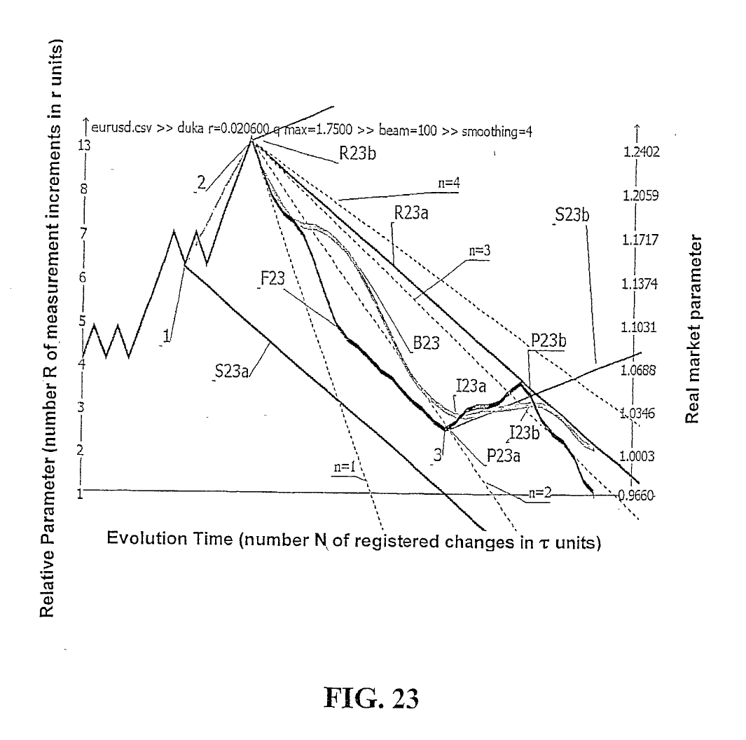

The system may be configured such that, after the definition of the coefficient q as guided by the system (in both FIGS. 22 and 23, qₘₐₓ=1.75), the user may enter the coordinates of the two points that, in the user's opinion, may belong to support and resistance lines. For example the user chooses points 1 and 2 in FIG. 22. After receiving these coordinates, the data processing system may be configured to automatically define the slope of the support and resistance lines (e.g., S22a, R22a) and subsequently plot the lines. In general, although the downward trend has not yet manifested itself in a visual manner in the vicinity of point 2, application of the method developed by the inventor allows the user to already foresee its direction and width by means of support and resistance lines S22a, R22a. After point 3 one may observe that the fastest trajectory goes upward but not enough to exit the corridor formed by lines S22a, R22a. Once again the general downward trend in FIG. 22 can be confirmed by plotting downward-sloping trend lines from points 1 and 2. Just after point 3, there are a number of intersections I22 of the fastest beam trajectory F22 and the beam-average curve B22. However all those intersections lie above the support line S22b of the upward-sloping trend, which is drawn through points 2 and 3. Therefore, if the user closed the position bargaining on the downward trend (“short position”) at the first intersection point within the I22 interval, he does not react to subsequent intersections. Only at the moment where the fast trajectory intersects the beam-average trajectory in the last point of the I22 section and subsequently intersects the support line drawn from point 3 does the user re-open his short position. Another method to improve analysis and avoid overreacting at each of these intersections I22, is to apply a filter of trajectory smoothing. As previously stated, the optimal number of repetitions of the smoothing process to obtain curves sufficiently smooth has been proposed as lying between about four and about ten. However, other numbers of iteration may be implemented to meet the design criteria of a particular implementation.

The fastest beam trajectory F23 and beam-average curve B23 shown in FIG. 23 represent the fastest beam trajectory F22 and beam-average curve B22 respectively of FIG. 22 after ten consecutive smoothing iterations. One may observe that the curves of the fastest trajectory F23 and the beam-average curve have been considerably smoothed. The intersection at point I23 of the two curves F23, B23 after smoothing provides a clearer signal for considering a possible change of trading position.

As previously discussed, several signals of the same trend reinforce each other. To identify in a more precise manner the general trend, it is helpful to plot support and resistance lines, as well as quantum lines and a development equation curve. FIG. 23 shows the support lines S23a and resistance lines R23a, drawn through points 1 and 2 respectively (exactly as S22 and R22 in FIG. 22).

The user can also decide to plot quantum lines n=1 to n=4 from point 2 by entering into the data processing system the coordinates of this point. The quantum lines are lines along which the trajectory in Increment-Change Space develops, jumping from time to time from one quantum line to the other. In general, analysis of trajectories with the quantum lines may be more effective when smoothing is applied. For example, due to smoothing, it is easy to determine point P23a as being the intersection of the fastest trajectory F23 by the quantum line n=2 right after point 3. The intersection at point P23a is an important signal indicating that the trajectory can “jump” higher towards the next quantum line or reverse the trend direction altogether. To obtain confirmation that the signal received at point P23a does in fact signify the beginning of a upward market correction, the user can also draw the lines of the possible upward trend through points 2 and 3, for example, the support line S23b and the resistance line R23b. Since point P23a lies above the support line S23b the user can conclude that the upward correction has indeed started. On the other hand the intersection of the same support line S23b in the opposite direction in point P23b generally signals the end of a market correction. Thus, by analyzing points 3, P23a and 123a, the user may identify three signals: first of all, point 3 is the point where a trend reversal may be supposed to begin; secondly, point P23a, which is the intersection of the fastest trajectory by the second quantum line, seems to confirm the supposed trend reversal; thirdly, point 123a, which is the intersection of the fastest trajectory by the mass center trajectory, confirms the opposite trend (upward-sloping). The three signals reinforce each other substantially. The user can interpret these three signals as being the moment to react and change his position for a short-term gain, speculating on the upward movement. Finally, after the re-intersection of the support line S23b in point P23b and the intersection of the fastest trajectory by the beam-average curve at point 123b located inside the downward-sloping trend, restricted from the top by the resistance line R23a, the user may conclude that the fall of the quote has resumed. The decision that may have been made based on the this analysis was confirmed in practice; after these signals the Euro declined by another 15 percent.

To refine the analysis even more, the user may obtain further information from other information analysis tools, such as the development equation curve.

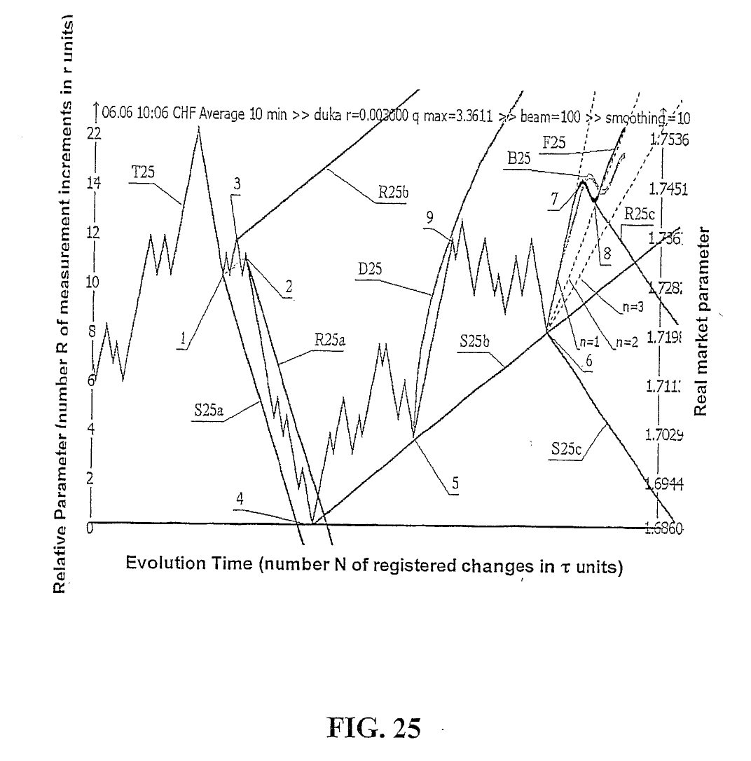

Referring to FIGS. 24 and 25, an example of a process using a development equation curve will be described below.

FIG. 24 shows a real chart of the US dollar Swiss franc (USD/CHF) exchange rate over the period from Apr. 15 to May 12, 2001, as provided by Reuters, based on ten minute USD/CHF quotes. Carrying out a transformation in Increment-Change Space with a measurement increment r=0.003 the trajectory T25 plotted in FIG. 25 may be displayed on the computer screen.

Referring to FIG. 25, a zone of stagnation between points 1 and 2 is shown. The zone may offer the user the possibility of obtaining the support and resistance lines S25a, R25a. The support and resistance lines S25a and R25a may provide the unique abc-solution to the compatibility equation by confirming the choice of the coefficient qₘₐₓ determined by the data processing system for the selected points 1 and 2. The points 1 and 2 may be selected, in one example, with a mouse curser. Right after point 4, where there is a sharp reversal of the general trend and the trajectory crosses the resistance line R25a, the user receives a clear signal to consider changing his trading position. The user may then also enter into the system the coordinates of points 3 and 4 to plot new support and resistance lines S25b and R25b. At point 5, the quote bounces off the support line S25b. In accordance with the present invented method, the user has an indication long before the emergence of point 5, that there is a possibility of market reversal upon the approach of the support line S25b by the trajectory T25. Based on the indication, the user may prepare in advance to take the necessary actions. After point 5, the user may speculate on an upward movement. However, to be cautious, the user may request the system to plot the development equation curve D25 with coefficient q=qₘₐₓ from point 5 upwards. Due to the fact that q=qₘₐₓ, the development equation curve D25 becomes the external envelope of any trajectory. Therefore, the user may speculate that approaching point 9, the market should start a correction since at this point, the trajectory T25 has reached the development equation curve. Taking that into account, the user can temporarily exit the position or even open a short term position at least until point 6, where the trajectory bounces off the support line S25b again.

To widen the illustration of other tools that may be applied, an example is examined where, at point 6, the user requests the transformation of the real curve into a beam with the number of trajectories equal to 100. Furthermore, a request is entered to carry out smoothing from the same point, with the number of cycles equal to 10, and plotting of the quantum lines n=1 to n=3. Let us consider the sequence of events that follows. Having reached the local high at point 7, the fastest trajectory F25 intersects the beam-average curve B25, which signals a downward trend. At this point, a risk-adverse user may temporarily close the position, but at point 8 the user may speculate in re-opening the long term position, because the fast trajectory F25 has bounced upwards off the second quantum line n=2. It is important to note that the upward bounce took place above the resistance line R25c of the possible downward trend drawn from points 6 and 7. Right after the bounce, the user receives additional confirmation of the open long term position as the fastest trajectory F25 intersects and outstrips the beam-average curve B25. The user may for example speculate to keep his position until the moment of the intersection of the beam-average curve by the fastest trajectory in the opposite direction.

Another simple but useful method of applying the development equation curve may be as follows. The q coefficient may have a critical value equal to qₘₐₓ/4. The position of the trajectory in relation to the development equation curve corresponding to the critical value of the q coefficient may be a conventional criterion of whether there is a directional market trend or whether it has already been dispersed. For example, if the trajectory outstrips the development equation curve or follows alongside it, then there exists a directional trend. If the trajectory intersects the development equation curve and falls behind, then the trend has been dispersed, i.e. the trend does not exist any more.

Of course, in comparison to the criteria used previously, the proposed criterion is not a precise tool and may give the user only a conventional signal, which is however simple and useful. The present invention may provide a system configured to offer the user a choice between several values of q which are most interesting from the point of view of practical applicability. The values may include, in one example, at least one value equal to qₘₐₓ and another value equal to qₘₐₓ/4.

IV.4)-a Overall Structure

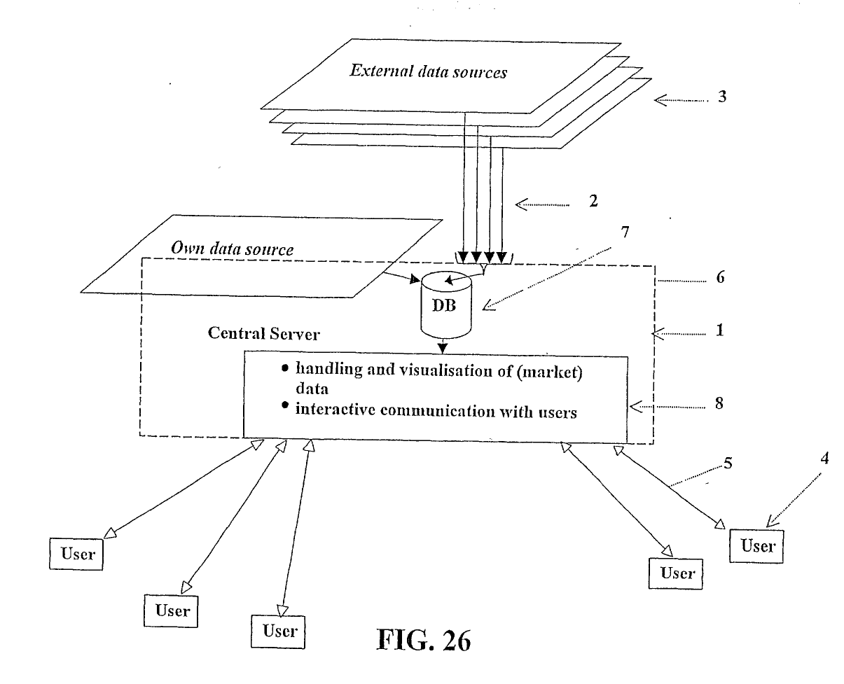

Referring to FIG. 26, a data processing system 1 in accordance with a preferred embodiment of the present invention is shown. The system 1 may be connected via communication lines 2, such as the internet or any other type of communication lines, to external data sources 3 for supplying real market data, and one or more user computers or terminals 4 via communication lines 5, that may for example be part of a global computer network, such as the internet or any other type of communication lines.

The data processing system 1 generally comprises, for example, a central server 6 (or a group of spread servers performing the functions of a central server) with an information storage section 7 and an information processing section 8. The information storage section 7 may be used in particular for storing databases of market data received from the external sources 3. The external sources may include, in one example, commercial market information suppliers or private (own) data sources. The various market data received and stored in the system 1 may comprise, for example, currency quotes, equity prices, and any other market values. Other information may also be received and stored, for example the history of trading operations and user accounts.

The information processing section 8 generally comprises a storage medium recording software (e.g., a computer program that is readable and executable by the system 1) configured for processing and displaying market information in real space and Increment-Change Space. The software may comprise various routines and processing modules for generating the various information analysis tools of the present invention that had been described previously. The software may further comprise programs for interactive communication with users, providing the information analysis tools and means for control and monitoring of the tools. The processing of information may comprise, for example, data selection from the database storage section 7. In one example, the processing of data may be also run on the user computer by downloading the processing software from the central server, or by software already installed on the user computer. The storage and processing of market data may be organized with different degrees of centralization or decentralization of database storage and information processing systems without parting from the scope of this invention.

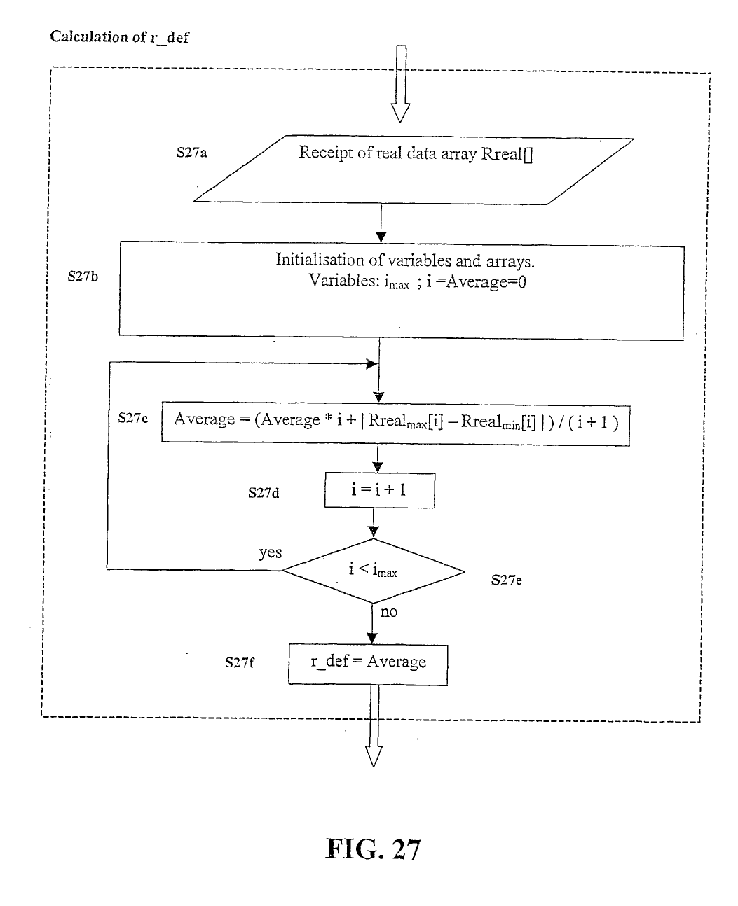

The software generally comprises a number of programs, processes and/or calculation modules for performing the transformation of real data into Increment-Change Space and for generating the various information analysis tools in accordance with the present invention. By way of example, the structure of some of the software programs or modules for generating information analysis tools in accordance with the present invention are described with reference to FIGS. 27 to 37.

IV.4)-b Software Programs/Modules

IV.4)-b1 Calculation of r_def

As mentioned above, real market data may inherently present a degree of error attributable to the spread of quoted values. The average spread of the quoted market values may be used to estimate the value of r_def The smallest useful value of the measurement increment r may be determined based on the value of r_def.

FIG. 27 illustrates a process for determining the value of r_def. In a step S27a, the data processing system 1 generally receives from the information storage 7 real market data as, in one example, a real data array Rreal[ ], (e.g., as an array containing the maximum and minimum real values, for example Rrealₘₐₓ [ ] and Rrealₘᵢₙ[ ], corresponding to the each real point in the real market database).

In a step S27b, the system generally initializes variables and arrays necessary to carry out the determination of r_def. The variable initializations may concern three variables: iₘₐₓ, (e.g., the number of the last point of the real data array); an iterative counter i (e.g., an ordinal number of a real point in the real data array, its starting value being 0 and its final value being equal to iₘₐₓ); and a variable “Average”, that generally accumulates the average difference between the maximum and the minimum real values, the starting value of which is 0. The array initializations generally concern the two above mentioned arrays Rrealₘₐₓ[ ] and Rrealₘᵢₙ[ ].

In a step S27c, for each value of i, in an iterative manner, the variable “Average” may be calculated in a cumulative way. In general, the value of the variable “Average” may be substantially or approximately determined by calculating an arithmetic mean. For example, a weighted mean (where the weight coefficients may be user-defined) or another averaged value may be applied.

In a step S27d, the counter i may be incremented by one.

In a step S27e, a decisional test may be executed to determine whether the counter i is less than a maximum value (e.g., iₘₐₓ) If the answer to the test is “yes” (e.g., if the counter i has not yet reached the maximum value), then the flow generally returns to the step S27c. If the answer is “no” (e.g., if the counter i has reached the maximum value), there is generally no more data in the real data array and the Average value as calculated is equal to r_def (e.g., the recommended minimum value of the measurement increment r for the transformation step). In the case where the system acquires new on-line data, the variable iₘₐₓ may take a new higher value and the calculations may be resumed until a new “no” reply to the test (e.g., block-scheme S27e).

If the analyzed data do not contain the minimum and maximum values for each point and are represented only by a single value for each point, for example, open price, then r_def may be defined as the average absolute value of the difference between the values of two neighboring points (e.g., as the average distance between all pairs of the neighboring points in the array).

IV.4)-b2 Transformation from Real Space to Increment-Change Space

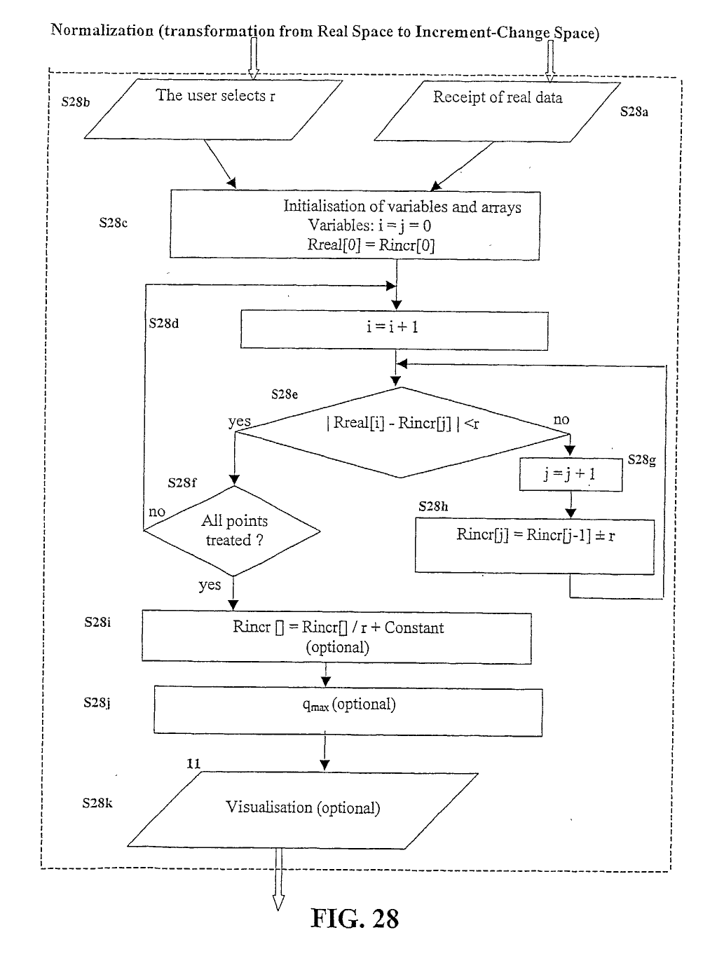

FIG. 28 generally illustrates a flowchart describing an example process for transforming the real market data into a trajectory in Increment-Change Space. In a step S28a, the system generally receives real data from the information storage 7. The data may be, for example, real-time market data, delayed market data, archived market data or any other type of real market data.

In a step S28b, the user may select (enter) the measurement increment r himself, choose as r the optimal increment r_def from the system or select the increment r while being guided by the recommended value r_def from the system. In general, although the method is applicable to any range of r, the optimal values of r are generally greater than or equal to the average amplitude r_def.

In a step S28c, the system initializes variables and arrays for carrying out the transformation. The variable initializations generally concern two variables: a first iterative counter i, that is the ordinal number of a real point in the real data array and a second iterative counter j, that is the ordinal number of the point in Increment-Change Space. Both starting values are generally set equal to 0. The array initializations generally concern two arrays, the real data array and the Increment-Change Space data array (e.g., Rreal[ ] and Rincr[ ]), both of which are initialized at 0 respectively for i=0 and j=0.

In a step S28d, the counter i is generally incremented by one.

In a step S28e, a decisional test may be executed (e.g., in an iterative manner) for a current i value to determine if the absolute value of the difference Rreal minus Rincr is less than r. If the answer to the test is “yes”, the corresponding real point i is generally not selected to fix the next Increment-Change Space point and the flow goes to a step S28f where it is verified whether all real points have been treated. If all the points have not been treated, the flow generally goes back to the step S28d. If all the points have been treated, the flow generally goes to a step S28i where the values of Rincr for all the Increment-Change Space points j are calculated according to the formula Rincr[ ]=Rincr[ ]/r+Constant, where the term Constant may be chosen in such a way that the values Rincr[ ] are integers. If the answer to the decisional test at the step S28e is “no”, the corresponding real point i is generally selected to fix a new Increment-Change Space point and the flow goes to step S28g where the counter j is incremented by one.

After the counter j is incremented, the vertical coordinate of the new selected point in Increment-Change Space may be calculated by adding +/−r to the vertical coordinate of the previously selected point. For every point in Increment-Change Space, i.e. for every j, the “+” or “−” sign is chosen in such a way that the point in Increment-Change Space moves in the direction of the current real point. As the main result, the parameter-normalized trajectory is obtained in the Increment-Change Space.

In an optional step S28j, the user may select the qₘₐₓ value calculated by the system. This optional step is described in more detail below in the section entitled “calculation of qₘₐₓ”. In a step S28k, the user can choose to visualize the trajectory in Increment-Change Space.

IV.4)-b3 Smoothing Method

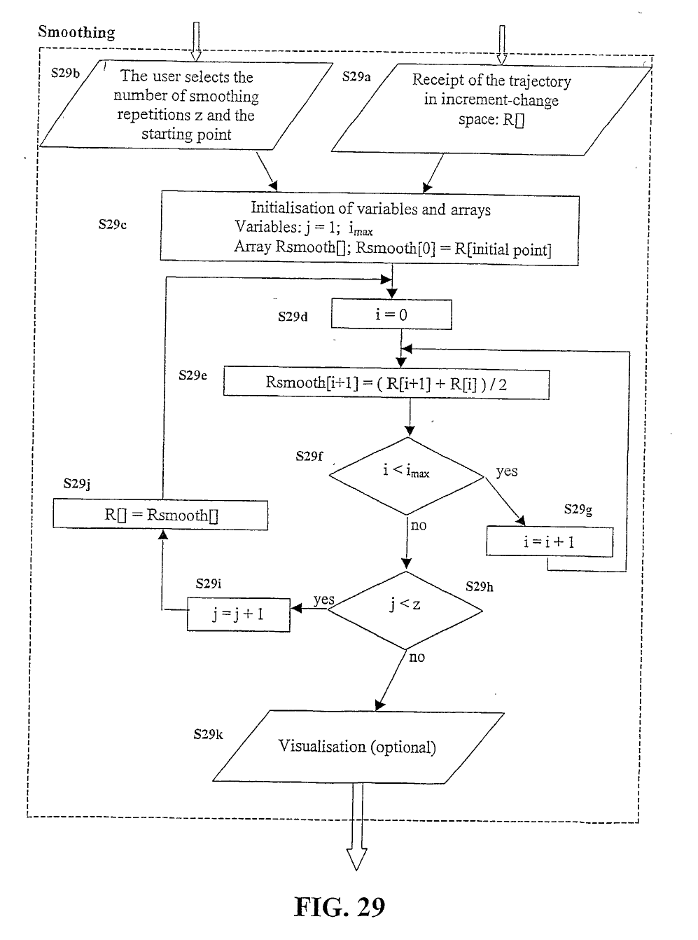

FIG. 29 illustrates a flowchart of a smoothing process. The smoothing process generally removes excessive “roughness” of a trajectory in Increment-Change Space. The smoothing process is generally repeated until the trajectory curve becomes sufficiently smooth to facilitate the analysis of the resulting image. An optimal number of repetitions generally lies between about four and about ten. However, the range is by no means exclusive; moreover, any other stopping criteria may be used. In particular one may exit the repetition loop when the latest change of the smoothed out parameter is less than a certain value.

In a step S29a, the system receives a trajectory in Increment-Change Space. The trajectory may be the parameter- or time-normalized trajectory as considered above, the fastest trajectory, the beam-average curve or any other trajectory in Increment-Change Space.

In a step S29b, the user enters the number of smoothing repetitions (e.g., z) and a starting point for the smoothing procedure.

In a step S29c, the system initializes variables and arrays for carrying out the smoothing process. The variable initializations generally concern two variables (e.g., an iterative counter j, that is the ordinal number of the smoothing, the starting value of which is generally 1, and a variable i_{incr}, that is the number of the last point in Increment-Change Space for the trajectory R[ ], with respect to the starting point of smoothing). The array initialization generally concerns Rsmooth[ ], the vertical coordinate array of points on the smoothed trajectory. The initial element of the array Rsmooth[ ] is generally initialized as Rsmooth[0]=R[initial point], where R[initial point] is R[ ] in the starting point of the trajectory to be smoothed. The counter i is the ordinal number of the point of the smoothed out trajectory with respect to the chosen starting point of smoothing process. At a step S29d the initial counter i is generally initialized to 0. In a step S29e, for every point i on the chosen normalized trajectory, Rsmooth may be calculated as being the average mean between its own value and its previous value.

In a step S29f, a decisional test may be run to determine if the ordinal number of the current point on the trajectory is less than the number of the last point in Increment-Change Space for the trajectory (e.g., i<iₘₐₓ), always with respect to the starting point of smoothing. If the answer to the test is “yes” (e.g., if the last point on the trajectory is not yet reached), then at a step S29g, the value of i is incremented by one and the flow returns to the step S29e. If the answer is “no” in the step S29f, the flow moves to a step S29h where a check is made of whether the ordinal number of the current smoothing is less than the number of repetitions of the smoothing method as defined in the step S29b. If the answer is “yes” (e.g., the number of repetitions is not reached), the flow moves to a step S29i where the ordinal number of the smoothing is incremented by 1 and the flow moves to a step S29j where a reassignment of the array Rsmooth[ ] into the array R[ ] is made. Then the flow returns to the step S29d. If the answer is “no” at the step S29h (e.g., the number of repetitions of smoothing as selected by the user is reached), the smoothing process is finished and the smoothed out trajectory may be displayed for visualization in a step S29k if desired by the user.

IV.4)-b4 Trend Line Plotting

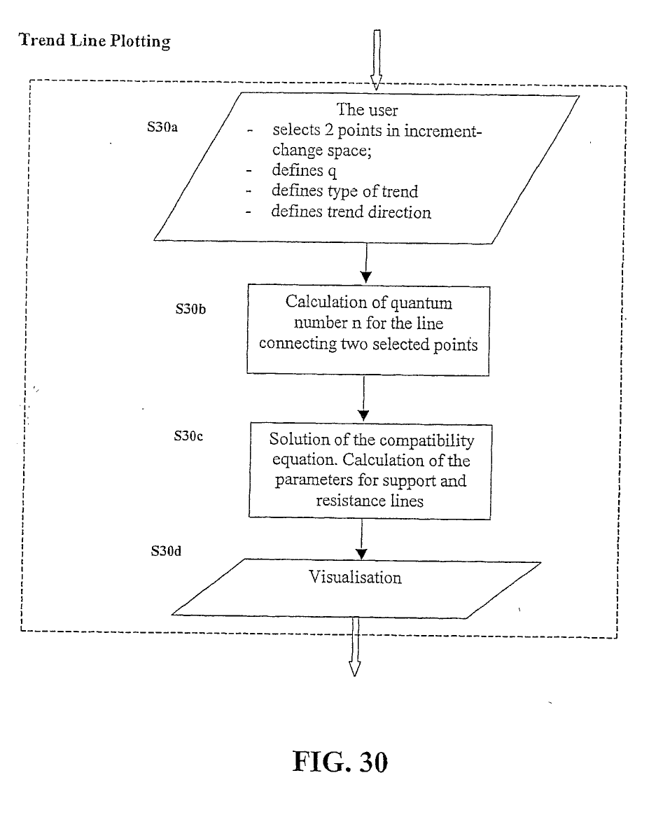

FIG. 30 illustrates a flowchart illustrating a process for trend line plotting. The trend line plotting process generally comprises plotting of the support and resistance lines. The calculation of parameters for support and resistance lines are generally based on the solution of the compatibility equation (30), described in detail in section III.1).

In a step S30a the user generally selects two points of the trajectory in Increment-Change Space. The user may enter a value for the coefficient q or may be guided by the data processing system as described in the next section IV.4)-b5. The user may also define the type of trend to be plotted, (e.g., alpha, beta, gamma or abc) and a direction of the trend.

In a step S30b, the system determines the quantum number n for the line connecting the points specified by the user (e.g., in accordance with formulae (38) and (40.2) above).

In a step S30c the system analyzes expression (33) to determine the possible types of existing compatible solutions. If condition (33) is fulfilled, it may be possible to define alpha- beta- and gamma-solutions (e.g., using formulae (32), (34), (35), (40.4) or (40.5) from section III.1). If the user chose q_max as the value of q, only alpha-solutions generally exist. Corresponding quantum numbers of the compatible trend are determined according to the formulae (32), (40.4) or (40.5). After calculating the specific value of the quantum number of the compatible trend, line slopes for support and resistance lines of the trend may be determined. Lines with angles of inclination determined by the slopes are drawn through the points specified by the user.

In a step S30d the system may be configured to produce a visualization of the support and resistance lines. This function is generally optional.

IV.4)-b5 Calculation of q_max

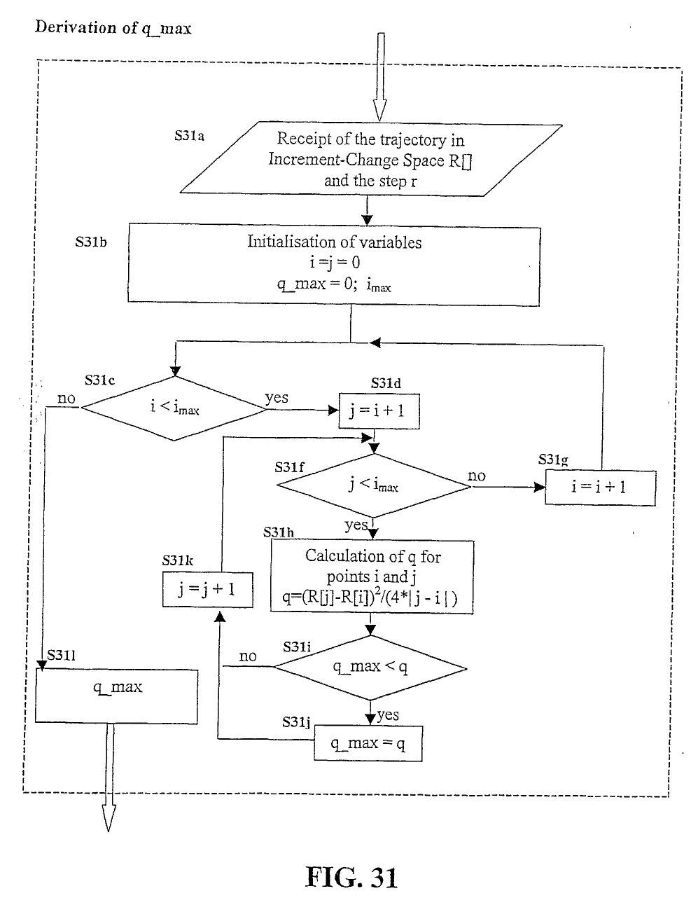

FIG. 31 generally illustrates a flowchart describing a process for determining a value for the maximum of all values of q corresponding to a specific range of analyzed data (e.g., q_max). Details of different ways of defining q_max are generally discussed in section IV.2)-e above. Determination of q-max may be optionally performed before the trend line plotting procedure described above in section IV.4)-b4, to assist the user in choosing the value of q.

In a step S31a, the system obtains a trajectory R[ ] in Increment-Change Space and the measurement increment r of the trajectory.

In a step S31b, the variables for carrying out the calculation of q_max are initialized. The variable initializations concern four variables: the number of the last point of the trajectory (e.g., iₘₐₓ); two iterative counters i and j that generally define the scanning of the trajectory and q_max. The counters i and j generally contain the ordinal number on the Evolution Time coordinate axis of a point on the trajectory. The counters i and j generally start with values of 0 and finish with final values equal to iₘₐₓ. The starting value of q_max is generally equal to 0.

In a step S31c, a decisional test is generally executed to determine if the counter i is less than its maximum value, iₘₐₓ. If the answer to this test is “yes”, (e.g., if the counter i has not yet reached its maximum value), the flow moves to a step S31d where the value of the counter i plus one is set as the value of the counter j. If the answer is “no”, (e.g., if the counter i has reached its maximum value), there are no more points on the trajectory and the q_max value is presented.

In a step S31f, a decisional test is executed to determine if the counter j is less than the maximum value of iₘₐₓ. If the answer to this test is “no”, (e.g., if the counter j has reached the maximum value) and there are no more points on the trajectory, then the flow moves to a step S31g where the counter i is incremented by one and the flow returns to the step S31c. If the answer is “yes”, (e.g., if the counter j has not yet reached the maximum value), the flow moves to a step S31h where q is calculated for the points i and j as expressed. Then the flow goes to a step S31i where the current value of q_max is compared to the obtained value of q. If q_max is less than q, then the flow goes to a step S31j to set q as q_max. By setting q_max to the greater value of q, the new q_max again has the maximum value. If q_max is greater than q, the flow goes to a step S31k where the counter j is incremented by one and the flow returns to the step S31f.

The determination of q_max generally uses a large amount of resources. Instead of determining q_max for every new point, q_max may be determined upon the receipt of a predefined number of new points. To speed up the calculations, an array of the inflection points of the trajectory (e.g., the points where the trajectory's direction changes) may be formed. The number of such points is generally smaller than the number of all points of the trajectory. Thus, using the array of inflection points to calculate the current value of q generally reduces the amount of resources and time used to carry out the calculations.

IV.4)-b6 Drawing the Second Trend Line

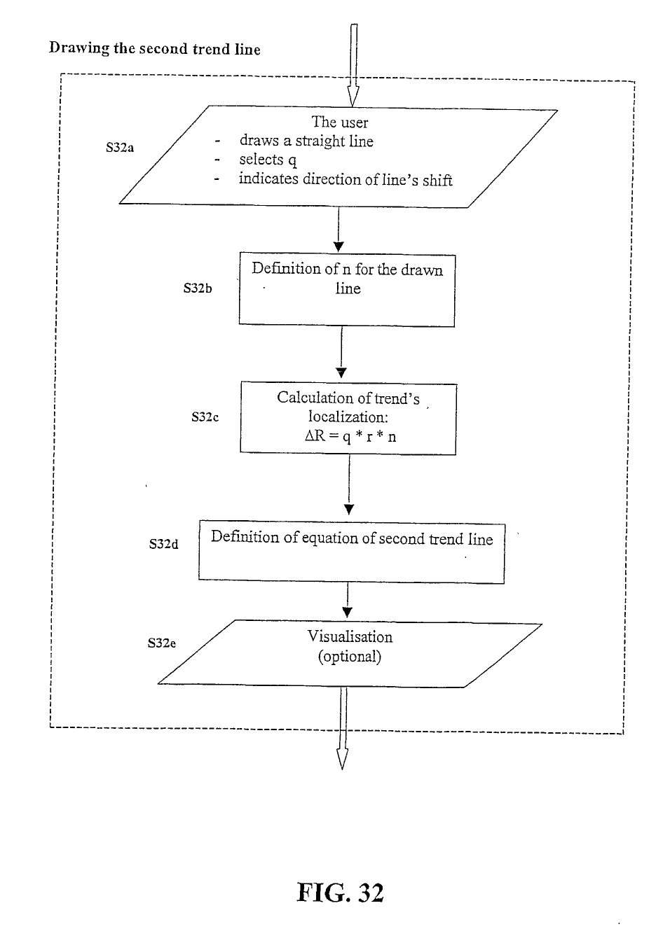

FIG. 32 illustrates a flowchart describing a process for drawing a second trend line (e.g., a complementary support or resistance line) in Increment-Change Space, after a first trend line has been drawn by the user.

In a step S32a, the user enters (e.g., draws by using, for example, a mouse or any other method of inputting line information) the first straight line in Increment-Change Space with increment r. The user enters the value of q, is guided by the system that calculates q_max, or allows the system to automatically determine q_max. The user may also indicate the direction of the shift to draw the second trend line.

In a step S32b, the system determines the quantum number n for the first drawn trend line. In a step S32c, the system determines the localization AR of the trend between the first drawn trend line and the second trend line to be drawn.

In a step S32d, the system determines the equation of the second trend line, which is parallel to the first one and shifted by AR in the direction as indicated (or entered) by the user in the step S32a.

In a step S32e, the system presents a visualization of the second trend line, if desired by the user.

IV.4)-b7 Splitting into Several Trajectories

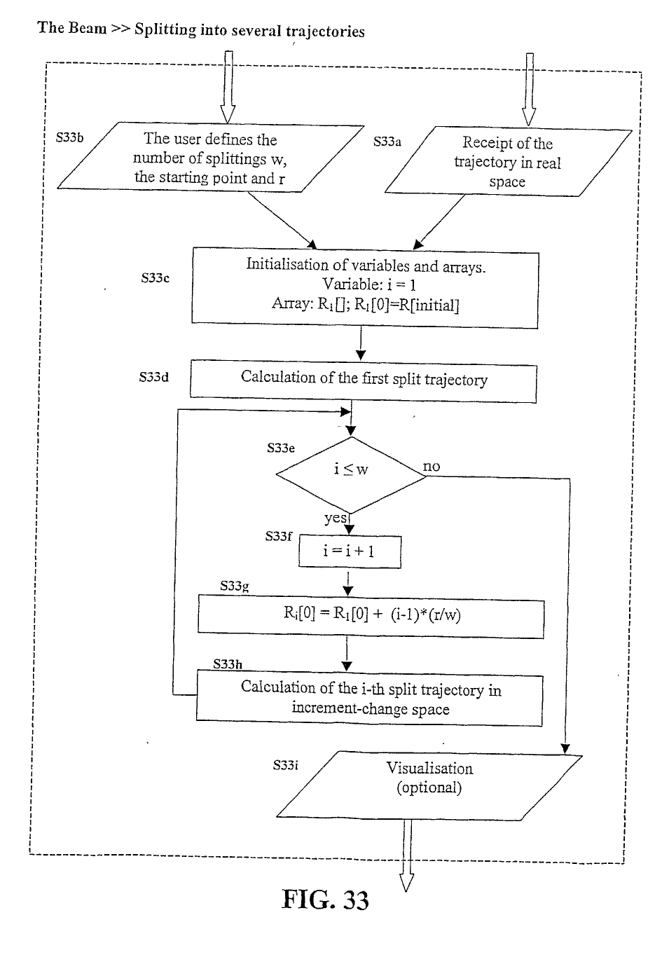

FIG. 33 illustrates a flowchart describing a process for transforming (splitting) the curve in real space into several trajectories in Increment-Change Space. The splitting method is generally illustrated in FIG. 5A, FIG. 6B and FIG. 8A, FIG. 8B and discussed in more detail in section II.1).

In a step S33a, the system obtains data of a curve in real space.

In a step S33b, the user enters a number of splittings w to be generated (e.g., the number of split trajectories to obtain) and a starting point from which to begin the splitting process. The user may specify the starting point in Increment-Change Space and the process may be configured to automatically identify the corresponding point in real space. When the user specifies the starting point in Increment-Change Space, the increment r is generally already defined. However, if the starting point is chosen differently, the value of r may be entered as well.

In a step 33c, variables and arrays for carrying out the splitting process are initialized. The variable initialization generally concerns one iterative counter i that defines the ordinal number of a split trajectory, the starting value of which is generally equal to 1. The value of the first starting point of the real trajectory is generally used for splitting R₁[0]=R[initial] which is generally equal to the value of the initial point of the trajectory in real space. In a step S33d, the first split trajectory in Increment-Change Space is determined. The process for determining a split trajectory is described above in section IV.4)-b7.

In a step S33e, a decisional test is executed to determine if the ordinal number of the current split trajectory is less than w (e.g., if the number w of splitting steps as defined by the user is reached or not). If the answer is “yes” (e.g., if the number of desired split trajectories is not yet reached), the iterative counter i is incremented by one in a step S33f. If the answer is “no” (e.g., if all the w split trajectories have been calculated), the flow moves to a step S33i where an optional visualization of the w split trajectories in the Increment-Change Space may be presented. Depending on the objectives of the user, the system may offer the capability to depict at the step S33i only a part of the derived trajectories or only the borders of such trajectories.

In a step S33g, the process determines, as expressed, for each splitting step i, the current starting point of the real trajectory, which may be used to obtain the current split trajectory. The starting points are generally stored into the one-dimensional arrays Rᵢ[0]. It is to be noted that it is possible to use Rᵢ[0]=R₁[0]-(i−1)*(r/w) as well as other methods of defining Rᵢ[0] instead of the one proposed in the step S33g, lying within R₁[0]+/−r. In general, all starting points of the w split trajectories in Increment-Change Space may be superimposed. In a step S33h, the i-th split trajectory in Increment-Change Space is determined and the flow returns to the step S33e.

IV.4)-b8 Determination of the Fastest Trajectory

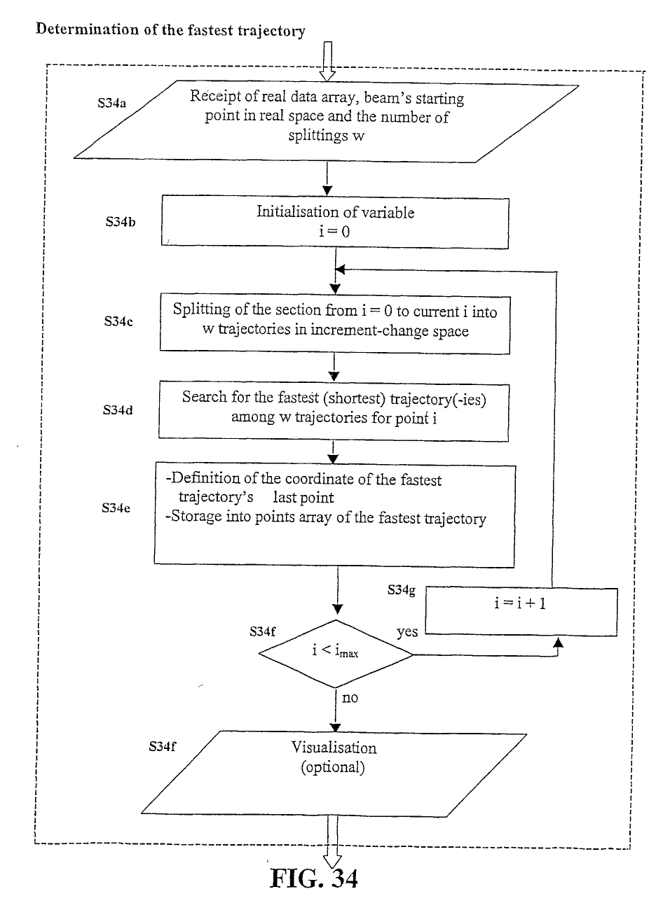

FIG. 34 illustrates a flowchart describing a process for drawing the fastest trajectory (see section IV.2)-c and IV-3)).

In a step S34a, the system obtains a real data array, the beam's starting point in real space and the number of splitting steps w.

In a step S34b, a single variable (e.g., i) for carrying out the splitting process is initialized. The variable i is generally the ordinal number of every point in the real data array, calculated from the starting point (the point of splitting into a beam). The initial value of i is generally 0 and the maximum value is generally iₘₐₓ, the ordinal number of the last point in the real data array.

In a step S34c, the section of the real data array from i=0 to the current value of i is generally split into w trajectories in Increment-Change Space.

In a step S34d, for every point i, a search is performed for the fastest trajectory or trajectories among the w split trajectories. The fastest trajectory is generally the same as the shortest trajectory. In general, there may be several fastest trajectories. The choice of a particular trajectory among the several fastest does not generally affect the final result.

In a step S34e, the coordinate of the last point of the fastest trajectory is determined and stored into the array of points of the fastest trajectory.

In a step S34f, a decisional test is executed to determine if the current value of i is less than iₘₐₓ (e.g., if the last point in the real data array is reached or not). If the answer is “yes” (e.g., if the last point of the array is not yet reached), the flow moves to a step S34g where the current i value is incremented by one. If the answer is “no” (e.g., if the end of the real data is reached), visualization of the fastest trajectory may be presented. Presentation of the fastest trajectory is optional.

IV.4)-b9 Determination of the Beam-Average Curve

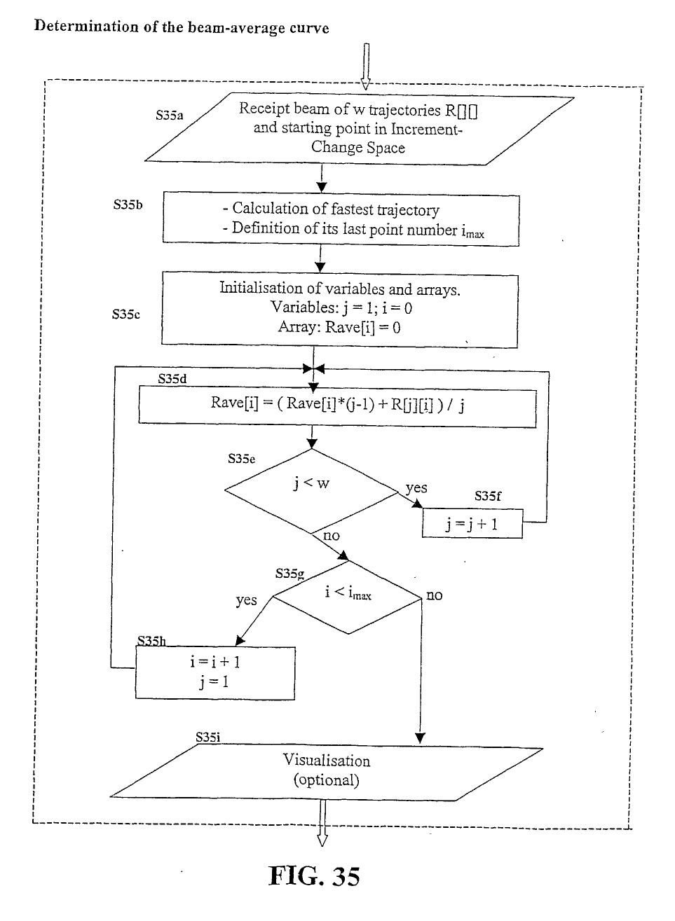

FIG. 35 generally illustrates a flowchart describing a process for drawing the beam-average curve. Detailed discussion on how the beam-average curve is determined can be found in section IV.2)-c.

In a step S35a, the beam of w trajectories (e.g., R[ ][ ]) and the starting point in Increment-Change Space of the beam are obtained.

In a step S35b, the fastest trajectory of the beam and the number iₘₐₓ of the last point of the fastest trajectory are determined. During the process of data handling, iₘₐₓ may increase if new data are obtained.

In a step S35c, variables and arrays for carrying out the determination of the beam-average curve are initialized. The variable initialization generally concerns two iterative counters (e.g., counter i and counter j). The counter i generally presents the ordinal number of every point in the data array R, calculated from the starting point, where the starting value is generally equal to 0. The counter j generally presents the ordinal number of the trajectory, where the starting value is generally equal to 1. The array initialization is generally an initialization at 0 of the value Rave[i] for all i, where Rave[i] is the array of points of the beam-average curve.

In a step S35d, for every i, Rave[i] is determined according to the following expression: Rave[i]=(Rave[i]*(j−1)+[j][i])/j.

In a step S35e, a decisional test is executed to determine if j is less than w (e.g., if the ordinal number of the trajectory is less than the number of trajectories). If the answer is “yes” (e.g., if the number of trajectories w is not yet reached), then the current value of j is incremented by one and the flow returns to the step S35d. If the answer is “no”, a decisional test is executed at a step S35g to determine if the current value of i is less than the number iₘₐₓ of the last point. If the answer is “yes” (e.g., if the last point is not yet reached), the current value of i is incremented by one and the ordinal number of the trajectory j is reset to one (e.g., the step S35h) and the process returns to the step S35d. If the answer is “no” in step S35g (e.g., if the last point on the current trajectory is reached), visualization of the beam-average curve may be presented. The presentation of the beam-average curve is optional.

IV.4)-b10 Drawing Quantum Lines

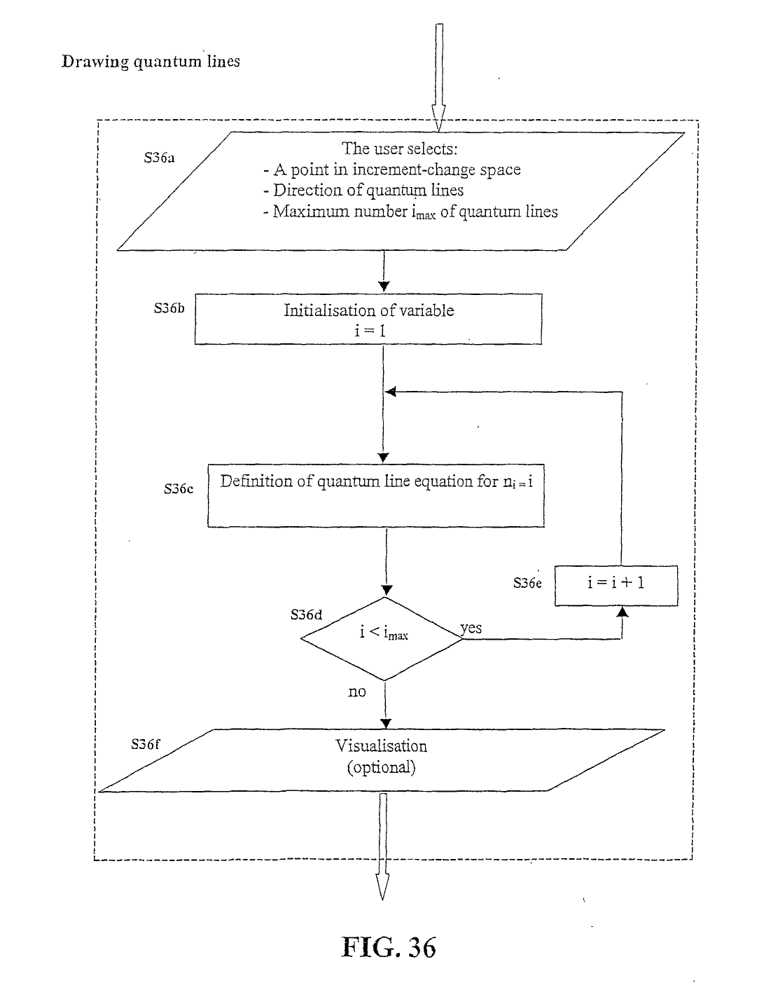

FIG. 36 illustrates a flowchart describing a process for calculating and drawing the quantum lines. Use of the quantum lines in analysis is described in more detail in section IV.2)-f above.

In a step S36a, the user selects (or enters) a point in Increment-Change Space, the direction—upward or downward—according to which quantum lines are to be drawn, and the maximum number iₘₐₓ of the quantum lines. Alternatively, instead of the maximum number of quantum lines, selected quantum numbers may be accepted.

In a step S36b, a single variable (e.g., i) for carrying out the drawing of the quantum lines is initialized. The variable i generally defines the ordinal number of the quantum line nᵢ. The starting value of the variable i is generally equal to 1.

In a step S36c, the quantum line equation is generally solved for the current quantum line nᵢ, where n, is equal to i.

In a step S36d, a decisional test is executed to determine if i is less than iₘₐₓ (e.g., if the maximum number of quantum lines has been reached or not). If the answer is “yes” (e.g., the maximum number of quantum lines is not yet reached), the flow moves to a step S36e where the current value i is incremented by one and the flow returns to the step S36c. If the answer is “no” (e.g., if the maximum number of quantum lines is reached), a visualization of the quantum lines as determined by the process may be presented. The presentation of the quantum lines is optional.

IV.4)-b11 Drawing the Development Equation Curve

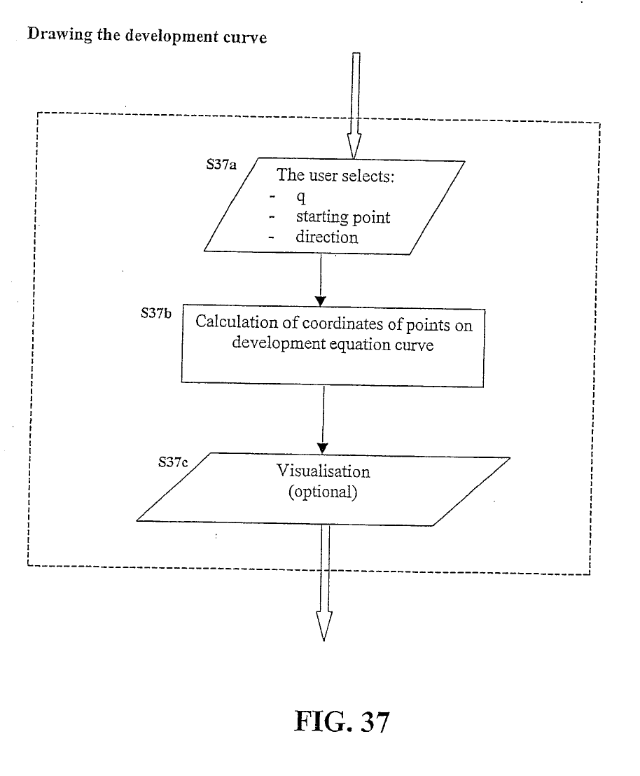

FIG. 37 illustrates a flowchart describing a process for determining and presenting the development equation curve. The use of the development curve in an analysis is discussed in more detail in section IV.2) above.

In a step S37a, the user selects (or enters) the value of q. If the user chooses q as q=qₘₐₓ, the development equation curve generally represents the external envelope of all trajectories as described in more detail above.

In the step S37a, the user may also select (or enter) the starting point for the development equation curve to be drawn and the direction of the development equation curve.

In a step S37b, the coordinates along the time axis of the points on the development equation curve may be determined according to the formula (42).

In a step S37c, a visualization of the development equation curve may be presented. The presentation of the development equation curve is optional.

The functions performed by the flow diagrams of FIGS. 27 to 37 may be implemented using a conventional general purpose digital computer programmed according to the teachings of the present specification, as will be apparent to those skilled in the relevant art(s). Appropriate software coding can readily be prepared by skilled programmers based on the teachings of the present disclosure, as will also be apparent to those skilled in the relevant art(s).

The present invention may also be implemented by the preparation of ASICs, FPGAs, or by interconnecting an appropriate network of conventional component circuits, as is described herein, modifications of which will be readily apparent to those skilled in the art(s).

The present invention thus may also include a computer product which may be a storage medium including instructions which can be used to program a computer to perform a process in accordance with the present invention. The storage medium can include, but is not limited to, any type of disk including floppy disk, optical disk, CD-ROM, and magneto-optical disks, ROMs, RAMs, EPROMs, EEPROMs, Flash memory, magnetic or optical cards, or any type of media suitable for storing electronic instructions.

While the invention has been particularly shown and described with reference to the preferred embodiments thereof, it will be understood by those skilled in the art that various changes in form and details may be made without departing from the spirit and scope of the invention.

1. A method for interactive user controlled processing of graphical images for financial data analysis, comprising the steps of:
(A) acquiring financial parameter data on a financial parameter to be analyzed in digital or electronic format;
(B) determining one or more lines, representative of an evolution of the financial parameter; and
(C) presenting the one or more lines in such a way, that when each new point of said one or more lines is plotted, a first coordinate along a first axis (T-axis) is incremented by a first value and a second coordinate along a second axis (R-axis) is changed by one of an increment by a second value and a decrement by said second value, wherein one of said first and second values is entered by the user.

2. The method according to claim 1, wherein each new point on the one or more lines is added when an absolute value of a difference between a current value of the financial parameter and the second coordinate along the second axis of a current point on the one or more lines is substantially equal to or greater than said second value, wherein when said difference is positive, the coordinate along the second axis is incremented by said second value and when said difference is negative the coordinate along the second axis is decremented by said second value.

3. The method according to claim 1, wherein each new point on the one or more lines is added for each time increment of said financial parameter, wherein a sign of said change in said second coordinate corresponds to a sign of a change in the financial parameter within said time increment.

4. The method according to claim 1, further comprising the steps of:
determining and presenting on a screen a curve substantially defined or approximated by an average of the second coordinates of said one or more lines for any coordinate along the first axis after a point entered by the user as a starting point for the one or more lines.

5. The method according to claim 4, wherein when the user specifies the second value, individual lines of said one or more lines are obtained by shifting the financial data values or said starting point by values smaller than the second value.

6. The method according to claim 4, wherein when the user specifies the first value, individual lines of said one or more lines are obtained by shifting a financial data time coordinate or said starting point by values smaller than the first value.

7. The method according to claim 5, further comprising the step of:
plotting an end point of one of said one or more lines having the smallest coordinate along said first axis on a screen; and
repeating said plotting step for subsequent financial parameter data to obtain a line of said end points.

8. The method according to claim 1 further comprising the step of:
smoothing at least one of said one or more lines by substituting the coordinates of each point with a new value determined substantially or approximately by an average of the coordinates of a current point and a preceding point.

9. The method according to claim 8, wherein the smoothing step is repeated one or more times to a line resulting from the previous smoothing step.

10. The method according to claim 1, wherein, said one or more lines comprise two substantially parallel straight lines determined by the equations
$$( \frac{R}{r} ) = A ( \frac{T}{τ} ) + {C}_{1} and ( \frac{R}{r} ) = A ( \frac{T}{τ} ) + {C}_{2}$$
where R defines the coordinate along the second axis T defines the coordinate along the first axis, and A is a coefficient related to the distance between said straight lines |C₁-C₂| according to the equation A |C₁-C₂|=q, where q is a numerical coefficient entered by the user or having a predetermined value.

11. The method according to claim 10, wherein in a first mode the user enters two points through which said two straight lines are to be drawn and in a second mode enters two points through which one of said two straight lines is to be drawn and further indicates whether said two points belong to the same line or whether said two points belong to two different lines.

12. The method according to claim 11, wherein the user further enters a direction in which said straight lines are to be drawn, and in the case where said two points belong to the same straight line, selects whether the second of said two straight lines is to be drawn higher or lower than the first of said two straight lines.

13. The method according to claim 1, wherein a plurality of said one or more lines intersect a point specified by the user, said lines being determined by the equation
$$( \frac{R}{r} ) = \frac{δ}{n} ( \frac{T}{τ} ) + C$$
where R defines the coordinate along the second axis, T defines the coordinate along the first axis, n is a positive integer excluding zero, δ=±1, and C is selected such that the plurality of straight lines pass through the specified point.

14. The method according to claim 1, further comprising the step of:
plotting a curve substantially defined or approximated by an equation
$${( \frac{{R}^{′}}{r} )}^{2} = δ * 4 q ( \frac{{T}^{′}}{τ} )$$
on a screen, where R′=R=R₀, T′=T−T₀ and R₀, T₀ are the coordinates along the second axis and the first axis, respectively, of a point defined by the user, δ=±1, and q is a numerical coefficient chosen by the user or defined by predetermined criteria.

15. The method according to claim 1, wherein said second value is determined by an average absolute value of a difference between neighboring values of said financial parameter data obtained as an array of values.

16. The method according to claim 1, wherein said second value is determined by an average difference between maximum and minimum values of an array of values of said financial parameter data, when said financial parameter data comprises minimum and maximum values for predetermined time intervals.

17. The method according to claim 1, wherein values of a coefficient q for one or more pairs of two different points of said one or more lines are determined according to an equation
$$q = \frac{{( Δ R / r )}^{2} τ}{4 * \vert Δ T \vert} ,$$
where ΔT and ΔR are a difference of first and second coordinates of said pair of points along the first and second axes, respectively.

18. The method according to claim 17, wherein the values of the coefficient q are determined for each pair of points of the one or more lines, and a maximum value qₘₐₓ is retained.

19. A method of processing financial parameter data comprising the steps of:
(A) acquiring real financial parameter data on a financial parameter to be analyzed in digital or electronic format; and
(B) providing one or more computer readable and executable instructions configured to transform the real financial parameter data to Increment-Change Space, said transformation comprising the operations of,
(i) determining a measurement increment r,
(ii) determining and registering a starting value of the financial parameter,
(iii) registering successive values of the financial parameter when a value thereof differs from a preceding registered value by the measurement increment r,
(iv) registering a number of successively registered changes of the financial parameter,
(v) determining and recording two-dimensional coordinates of evolution of the financial parameter in Increment-Change Space, wherein a first coordinate parameter represents a registered relative financial parameter value as a number of measurement increments r and a second coordinate parameter represents an Evolution Time as the number of successively registered changes.

20. The method according to claim 19, wherein said transformation operations are repeated for one or more iterations with the starting value of said financial parameter in each iteration differing from the starting value used for a previous transformation by a value smaller than the measurement increment r.

21. The method according to claim 20, wherein an average value of the first coordinate parameter is determined and recorded for each value of the number of successively registered changes.

22. The method according to claim 19, further comprising the steps of:
plotting and displaying on a screen one or more trajectories of recorded two-dimensional coordinates on a two-dimensional chart with a first axis having a scale of numbers representing a relative value of the financial parameter as a number of the measurement increments r and a second axis having a scale of numbers representing Evolution Time as a number N of successively registered changes.

23. The method according to claim 22, further comprising the steps of:
selecting two points of the one or more trajectories;
setting a first point of said two points as an origin of a curve; and
plotting on the screen a development curve from said first point of origin and passing through a second point of said two points, said curve substantially following a relationship expressible as R(t)/r=2\sqrt{qt}, where R(t) is a value of the curve coordinate along the first axis as a function of Evolution time, t is Evolution Time, and q is a coefficient determined by entering the coordinates of the second point into the relationship.

24. The method according to claim 22, further comprising the steps of:
selecting a point of the one or more trajectories; and
plotting on the screen a development curve from said point, set as an origin, said development curve substantially following the relationship R(t)/r=2\sqrt{qt}, where R(t) is a value of the curve coordinate along the first axis as a function of Evolution time, t is Evolution Time, and q is a numerical coefficient.

25. The method according to claim 22, further comprising the steps of:
selecting two points of the one or more trajectories; and
determining and drawing on the screen substantially parallel resistance and support lines through first and second points, respectively, of said two points, said lines satisfying the equations R₁(t)/r=b*t+c₁, R₂(t)/r=b*t+C₂, where R₁(t) and R₂(t) are values of said line coordinates along the first axis as a function of Evolution time, t is Evolution Time, b is substantially equal to qr/ΔR, c₁, c₂ are calculated such that said lines pass through said first and second points, q is a numerical coefficient, r is the measurement increment, and ΔR is the difference in a relative financial parameter value of the first point with respect to the second point.

26. The method according to claim 22, further comprising the steps of:
drawing or defining by a user a first support or resistance line satisfying the equation R(t)/r=b*t+c, where R(t) is the value of the line coordinate along the second axis as a function of Evolution time, t is Evolution Time, and b, c are numerical coefficients;
determining coefficients b and c of the first support or resistance line; and determining and drawing on the screen a substantially parallel complementary resistance or support line, respectively, at a distance ΔR along the second axis from the first line, wherein ΔR is substantially equal to k·q·r·n where q is a numerical coefficient, r is the measurement increment, k=±1 and n is an inverse of the coefficient b of the first support or resistance line.

27. The method according to claim 22, further comprising the steps of:
selecting two points of the one or more trajectories; and
determining and drawing on the screen substantially parallel resistance and support lines through first and second points, respectively, said lines satisfying the equations R₁(t)/r=b·t+c₁, R₂(t)/r=b·t+c₂, respectively, where R₁(t), R₂(t) are the values of said line coordinates along the first axis as a function of Evolution time, t is Evolution Time, and b is equal to one of 1/n_{β}, 1/n_{γ}, 1/n_{α}, 1/n_{abc} and 1/nₜ, wherein n_{β}, n_{γ}, n_{α}, n_{abc}, and nₜ are determined according to the following relationships,
n_{β}=ΔR/2 qr+(ΔR²/4q²r²−ΔR n/qr)^{0 5},
n_{γ}=ΔR/2 qr−(ΔR²/4q²r²−ΔR n/qr)^{0 5},
n_{α}=ΔR/2 qr+(ΔR²/4q²r²+ΔR n/qr)^{0 5},
n_{abc}=ΔR/2 qr,
nₜ=(ΔT/q)^{0 5},
where q is a numerical coefficient, r is the measurement increment, ΔR is an absolute value of a difference in the relative parameter value of the first point with respect to the second point, ΔT is an absolute value of a difference in Evolution Time coordinate of the first point with respect to the second point, 1/n is a slope of a straight line joining two selected points and c₁, c₂ are calculated such that said lines pass through said first and second points.

28. The method according to claim 22, further comprising the steps of
selecting a point of the trajectory; and
determining and plotting on the screen one or more quantum lines starting from said point and having a slope equal to 1/n, where n is an integer.

29. The method according to claim 22, wherein a coefficient q is determined by:
selecting a first point of one of said one or more trajectories as a starting point;
selecting a second point of the trajectory;
determining a difference ΔR between the first axis coordinate of the selected first and second points;
determining a difference ΔT between the second axis coordinates of the selected first and second points;
setting a value for q according to the equation (ΔR/r)²/4ΔT.

30. The method according to claim 29, further comprising the steps of:
selecting a new second point of the trajectory;
repeating the steps of claim 29; and
repeating the above iteration with the remaining points of the trajectory and selecting a maximum value for the coefficient q.

31. The method according to claim 30, further comprising the step of:
selecting a new first point of the trajectory;
repeating the steps of claims 29 and 30 for a number of iterations until all points of the trajectory have been selected as first points; and
selecting the maximum value of the coefficient q from all of the iterations.

32. A storage medium for use in a computer for calculating a measurement increment r for transforming financial parameter data as set forth in the method according to claim 19, the storage medium recording a computer program that is readable and executable by the computer, the computer program adapted to perform the steps of:
A) receiving real financial parameter data from an information source as a real data array (Rreal [ ]) comprising maximum and minimum real values (Rrealₘₐₓ [ ] and Rrealₘᵢₙ[ ]);
B) initializing a number of variables, iₘₐₓ, and “Average”, where iₘₐₓ comprises a number of real points in the real data array, i comprises an ordinal number of a real point in the real data array, initially set at 0 and “Average” comprises a variable configured to accumulate an average difference between the maximum and the minimum real values, initially set at 0;
C) calculating the variable “Average” in a cumulative way expressible by the formula
Average=(Average*i+|Rrealₘₐₓ, [i]−Rrealₘᵢₙ[i ] |)/(i+1);
D) incrementing i by one; and
E) executing a decisional test to determine if i is less than iₘₐₓ, wherein when i is less than iₘₐₓ the program returns to step c) and when i is equal to or greater than iₘₐₓ the program sets the measurement increment r to the value of “Average”.

33. A storage medium for use in a computer for transforming real financial parameter data into a trajectory in Increment-Change Space according to claim 19, the storage medium recording a computer program that is readable and executable by the computer, the computer program adapted to perform the steps of:
(A) receiving real financial parameter data from an information source as a real data array (Rreal [ ]);
(B) selecting or receiving a value of a measurement increment (r);
(C) initializing an ordinal number i of a real point in the real financial parameter data and an ordinal number j of a point in Increment-Change Space at 0 and initializing a first value (Rincr [0]) of an Increment-Change Space data array (Rincr [ ]) as being equal to a first value Rreal [0] of said real data array (Rreal [ ]);
(D) incrementing i by one;
(E) executing a decisional test to determine if an absolute value of a difference of a value of said real data arrays pointed to by i (Rreal [i]) minus a value of said Increment-Change Space pointed to by j (Rincr [j]) is less than the measurement increment r, wherein if the answer is “no”, incrementing j by one, calculating a new coordinate value Rincr [j] along a relative parameter axis of a new point j in Increment-Change Space by adding or subtracting the measurement increment r to a previous coordinate value Rincr [j−1], and returning to the beginning of the step (E), and if the answer is “yes”, verifying if all real points have been treated and if the answer is “no”, returning to step (D);
(F) determining the value of Rincr [j] or the Increment-Change Space point j corresponding to the real point i according to the formula Rincr [j]=Rincr [j]/r+constant, where the constant is chosen in such a way that the values Rincr [j] comprise integers.

34. The storage medium according to claim 33, further configured for smoothing a trajectory in Increment-Change Space Space to perform the steps of:
(A) receiving the trajectory in Increment-Change Space;
(B) selecting a number of repetitions z for smoothing the trajectory and coordinates of a starting point for smoothing;
(C) initializing the ordinal number j of the smoothing at a value of 1 and the number of the last point of the trajectory in Increment-Change Space i_{incr} with respect to the starting point for smoothing and equalizing to each other (R[0] and Rsmooth [0]) the coordinates, along a number of measurement increments axis of the starting point of the trajectory and of the smoothed trajectory;
(D) initializing the ordinal number of the current point on the trajectory i with a value of 0;
(E) calculating Rsmooth as being the average between its own value and its previous value;
(F) executing a decisional test to determine if i<i_{incr}, wherein if the answer is “yes”, incrementing i by one and going back to the step (E), and otherwise
(G) verifying if the ordinal number of the current smoothing j is less than the number of repetitions z for the smoothing process as defined in the step (B), wherein if the answer is “yes”, incrementing the ordinal number j of the smoothing process by 1 and reassigning the array Rsmooth [ ] into the array R [ ] then going back to the step (D) and if the answer is “no”, the smoothing process is finished.

35. A storage medium for plotting trend lines according to claim 26, the storage medium recording a computer program that is readable and executable by the computer, the computer program adapted to perform the steps of:
selecting two points in Increment-Change Space, defining a coefficient q and selecting a direction of shift in said trend lines;
determining parameters of a first of said trend lines drawn through said points;
determining a distance ΔR according to the method as set forth in claim 26; and
determining parameters of a second of said trend lines.

36. A storage medium for use in a computer for trend line plotting according to claim 27, the storage medium recording a computer program that is readable and executable by the computer, the computer program adapted to perform the steps of:
selecting two points in Increment-Change Space and defining a coefficient q;
selecting the type of trend to be plotted as one of alpha, beta, gamma, abc and t and defining a direction of the trend;
executing a decisional test to verify whether the solution of the corresponding equation for the selected type of a trend quantum number exists;
if the answer is “yes”, calculating a quantum number n according to the method as set forth in claim 27 for a line connecting the selected points; and
determining parameters for support and resistance lines according to the method as set forth in claim 27.

37. A storage medium for use in a computer for calculating the value of a coefficient qₘₐₓ, the storage medium recording a computer program that is readable and executable by the computer, the computer program adapted to perform the steps of:
(A) receiving a trajectory in Increment-Change Space and a measurement increment r,
(B) initializing a number iₘₐₓ of a last point of the trajectory, two iterative counters i and j that control a scanning of the trajectory at 0 and a starting value of qₘₐₓ at 0;
(C) executing a decisional test to determine if i is less than iₘₐₓ;
(D) if the answer is “no”, calculating the value of the coefficient qₘₐₓ if finished;
(E) if the answer at the step (C) is “yes”, setting at i plus one;
(F) executing a decisional test to determine if j is less than iₘₐₓ, wherein if the answer is “no”, incrementing i by one and going back to the step (C) and if the answer is “yes”, calculating q for points i and j as q=((R[j]−R[i])/r)²/(4*|j−i|), where R[i] and R[j] are the coordinates of points i and j along a number of measurement increments axis; and
(G) if qₘₐₓ is less than q, then storing q into qₘₐₓ, incrementing j by one then going back to step (F).

38. A storage medium for use in a computer for splitting a trajectory of financial parameter data according to the method of claim 21, the storage medium recording a computer program that is readable and executable by the computer, the computer program adapted to perform the steps of:
(A) receiving a trajectory;
(B) selecting a number of splitting steps w and coordinates of a starting point of the splitting steps;
(C) initializing an ordinal number i of each split trajectory at 1 and a starting point of the first split trajectory in Increment-Change Space (R₁[0]) at 0;
(D) determining a first split trajectory in Increment-Change Space;
(E) executing a decisional test to determine if i is less than w, wherein if the answer is “no”, the process of splitting a trajectory is finished and if the answer is “yes”, incrementing i by one;
(F) determining a starting point, along a number of measurement increments axis, of a current split trajectory according to the relationship Rᵢ[0]=R₁[0]+(i−1)*(r/w); and
(G) determining an i-th trajectory in Increment-Change Space and returning to step (E).

39. A storage medium for use in a computer for drawing a fastest trajectory, the storage medium recording a computer program that is readable and executable by the computer, the computer program adapted to perform the steps of:
(A) receiving a trajectory representing real financial parameter data according to the method of claim 21, a starting point and a number of splitting steps w;
(B) initializing at 0 an ordinal number i of each point on the trajectory, calculated from the starting point, wherein i has a maximum value of iₘₐₓ;
(C) splitting a section of the trajectory from i=0 to the current value of i into w trajectories in Increment-Change Space;
(D) searching for one or more fastest trajectories among the w split trajectories;
(E) defining a coordinate, along a number of measurement increments axis, of a last point of the fastest trajectories and storing the coordinate in an array of points of the fastest trajectory; and
(F) executing a decisional test to determine if i is less than iₘₐₓ, wherein if the answer is “yes”, incrementing i by one and returning to the step (C).

40. A storage medium for use in a computer for drawing a beam-average curve, the storage medium recording a computer program that is readable and executable by the computer, the computer program adapted to perform the steps of:
(A) receiving a beam of w trajectories (R[ ][ ]) and a starting point for the beam in Increment-Change Space;
(B) determining a fastest trajectory of the beam according to claim 38 and defining a number iₘₐₓ of a last point of a fastest of said trajectories;
(C) initializing an ordinal number i of each point in a data array R, measured from a starting point, to 0, an ordinal number j of the trajectory to 1, and Rave [i] for all i to 0, wherein Rave [I] comprises an array of points of the beam-average curve;
(D) determining a value of the beam-average curve coordinate along a number of measurement increments axis according to a relationship Rave [i] as Rave [i]=(Rave [i]*(j−1)+R[j] [i])/j; and
(E) executing a decisional test to determine if j is less than w, wherein if the answer is “yes”, incrementing j by one and going back to the step (D) and if the answer is “no”, executing a decisional test to determine if i is less than a number N and if the answer is “yes”, incrementing i by one and resetting j to one.

41. A storage medium for use in a computer for drawing quantum lines according to the method of claim 28, the storage medium recording a computer program that is readable and executable by the computer, the computer program adapted to perform the steps of:
(A) selecting a point in Increment-Change Space, a direction—upward or downward—according to which of a number of quantum lines are to be drawn, and a maximum number iₘₐₓ of the quantum lines;
(B) initializing the ordinal number i of a quantum line to 1;
(C) determining a quantum line equation for the current quantum line i; and
(D) executing a decisional test to determine if i is less than iₘₐₓ, wherein if the answer is “yes”, then incrementing i by one and going back to the step (C) and if the answer is “no”, the process of drawing quantum lines is finished.

42. A storage medium for use in a computer for drawing a development curve, the storage medium recording a computer program that is readable and executable by the computer, the computer program adapted to perform the steps of:
(A) selecting a coefficient q, a starting point for a development curve to be drawn and a direction of the development curve; and
(B) determining coordinates along an Evolution Time axis of points on the development curve according to a relationship R/r=2\sqrt{qt}, where R is a value of the curve coordinate along the Evolution Time axis, t is Evolution Time, r is a measurement increment, and q is a numerical coefficient.
